(19) United States
(12) Patent Application Publication
(10) Pub. No.: US 2026/0267495 A1
(43) Pub. Date: Sep. 10, 2026

(54) CUSTOMIZING DELIVERY OF INFORMATION STREAMS TO USER DEVICES

(71) Applicant: MicroStrategy Incorporated, Vienna, VA (US)

(72) Inventors: William Ivan Hurwood, Washington, DC (US); Deepak Karuppiah, Vienna, VA (US); Shrimohan Damani, Aldie, VA (US); Jun Zhu, Potomac, MD (US); Jackson Wonderly, Fairfax, VA (US); Yufei Chen, Fairfax, VA (US); Ji Jin, Vienna, VA (US); Yan Li, Fairfax, VA (US); Fang Niu, Fairfax, VA (US); Sergio Trejo-Rodriguez, Oakton, VA (US)

(21) Appl. No.: 19/538,558

(22) Filed: Feb. 12, 2026

Related U.S. Application Data
(60) Provisional application No. 63/768,221, filed on Mar. 7, 2025.

(51) Int. Cl. G06F 3/04847; G06F 40/186

(52) U.S. Cl. CPC G06F 3/04847; G06F 40/186

(57) ABSTRACT

Systems, methods, and apparatus, including computer-readable media, for customizing delivery of information streams to user devices. In some implementations, a system provides an interface configured to create or edit information card templates for a channel configured to provide information cards based on the templates to user devices. The system receives first input through the interface that indicates content of a first information card template. The system receives second input that specifies one or more criteria for presenting an information card based on the first information card template. The system stores a record for the first information card template that indicates (i) the content indicated by the first input and (ii) one or more criteria specified by the second input. The system configures the channel to provide information cards based on the first information card template.

### CROSS-REFERENCE WITH RELATED APPLICATIONS

This application claims priority to U.S. Provisional Patent Application No. 63/768,221, filed on Mar. 7, 2025, the entire contents of which are incorporated by reference herein.

### BACKGROUND

The present specification relates to assessing and delivering information in networked computing platforms.

Enterprise computer systems have increasingly large amounts of information of various types, such as customer relationship management databases, calendar data, email repositories, messaging data, and more. As the volume of data and diversity of data increases, it can be difficult for users to identify and access the information that is most relevant to them, especially when the data may be spread across multiple locations or systems.

### SUMMARY

In some implementations, a computer system provides a platform that enables a diverse set of enterprise data to be presented to users efficiently based on the context of the users. The system enables administrators to define channels that provide information from certain sources or for particular topics. The channels can be customized to provide particular types of content in response to particular events, triggers, or conditions, so that relevant information is selected and provided when it is useful for a user's particular task, activity, or user interface content. Users can connect or subscribe to different channels, and the system can combine information from the various channels to provide a cohesive stream of relevant information. For example, for each user, the system can identify information cards triggered as relevant to the user based on the user's user interface content and activity, rank or prioritize the information cards, and provide the ranked information cards in a stream or feed for the user. The system can repeatedly update the contents of the stream, so that the contents of the stream changes based on changes in the user interface of the user's device, based on changes to data sets, based on new information from other systems, based on the passage of time, and other events and conditions that adjust the relevance or importance of different information cards to the user. As a result, the system can provide each user a stream of information that is customized for that user and brings together information from various data sources and also third-party systems, and is updated in an ongoing manner to complement the user's other activities and interfaces.

The platform can use artificial intelligence or machine learning (AI/ML) models, such as large language models (LLMs), to perform or enhance many of its functions. For example, the system can use AI/ML models to generate information cards and other content for a user's stream, such as by processing a card template and data from a data source and generating information card data based on the template. As another example, the system can use AI/ML models to identify new types of information cards or content to be provided. As another example the system can use AI/ML models to identify the conditions or events that trigger the generation or display of information cards or other stream content. In some cases, the AI/ML models can analyze user behavior and user activity to recommend information card types and corresponding conditions in which to display those types of information cards, allowing the AI/ML models to allow the system to learn characteristics of relevance and importance at the level of an individual as well As for groups of individuals, channels, and more generally. Even when an administrator is manually adjusting operations of the system, the AI models can assist in implementing desired behavior. For example, the system can allow administrators to specify a condition in natural language, and the system can use the AI/ML models to generate an expression that a computer system can use to detect the presence of the condition (e.g., an expression referencing database field values, a structured query language statement, computer code, etc.).

In some implementations, the presentation of a stream of information to a user is facilitated by a local extension module or add-on module that runs alongside a web browser or another application (e.g., document editor, e-mail application, spreadsheet application, etc.). The local extension module can be presented in various different forms. For example, the extension module can display or alter the appearance of an icon when stream content is available. The extension module can also be presented as a sidebar or overlay, which can make stream content available to the user without the user having to switch between applications or exit the task or project the user is engaged in.

The system can be provided to enterprises and other organizations as a software-as-a-service (SaaS) product. A server system can handle the collection of context data from users as well as manage the acquisition of data from various data sources, including an enterprise's own databases or data sets and third-party data sets and information from third party systems and services. The server system also coordinates processing of the AI/ML models and processing to determine when various information cards are triggered, and also manages the ranking and delivery of information card content to the streams for various users.

The system can combine the strengths of traditional computer architectures and database systems with those of AI/ML models to efficiently manage the delivery of relevant information to many users based on their respective contexts. AI/ML models have many capabilities, but inference processing can incur significant latency, power consumption, and cost due to the computational requirements. In some cases, the system can use AI/ML models to generate content for information cards or other stream output to users. However, in some implementations, the AI/ML models are applied to higher-level functions where they can more efficiently adjust behavior of the system without needing to generate individual content items.

For example, the system can be configured to use AI/ML models to analyze user interaction data to learn the trends among user behavior and to determine the conditions in which particular types of information are useful for users. The system can then express the patterns and relationships determined by the AI/ML models in rules and conditions that a database system can evaluate efficiently at scale. Thus, all users can benefit from the pattern analysis and natural language understanding of the AI/ML models, as it is incorporated into the triggering functionality for selectively displaying of information, even as each instance of information card output does not require its own corresponding AI/ML model inference processing.

As another example, AI/ML models can be used to create mappings between data sources and keywords, to identify data objects or elements of data sources that represent certain phrases or natural language references. Once the AI/ML are used to create these links or associations, the system can use very fast and efficient database processing (e.g., deterministic, non-AI techniques) to retrieve and provide those types of information. For example, the AI/ML model can identify a logical object (such as a metric, attribute, or database column) that corresponds to a natural language phrase, and then the system can use that link to connect a data source or generate an information card template. The system can later populate information in the information card template to generate information cards for many different users without needing to query the AI/ML model each time.

The system's use of the AI/ML models can also improve the accuracy of the information provided to users compared to other AI-enabled systems. AI/ML models incorporate many correct facts through their training, but they can also be susceptible to outputting hallucinations that seem plausible but are incorrect. In many cases, the system can limit the risks of hallucinations and other AI inaccuracies by using the AI/ML models to make connections among data sources and to assess the values and facts in the data sources rather than generating content directly. For example, the system can use AI/ML models in the process of defining information card templates and conditions for providing the information cards can avoid the risk of providing incorrect information to users. This limits the impact or effect of errors by AI/ML models, because even if an AI/ML model incorrectly indicates that a particular type of information is relevant or timely for a user, providing accurate information at an time when it is not needed is a relatively minor error that is less serious than providing information that is actually incorrect. In addition, discussed further below, the system includes features that enable the system to learn and adjust settings for content relevance and triggering conditions over time, e.g., based on user behavior and preferences of administrators and users, and these feedback mechanisms can quickly improve the performance of the system even if the behavior specified by the AI/ML models is not ideal.

In the system, the values or facts that are presented can be drawn from the actual data sources and databases the administrators specify. As a result, although the AI/ML models can be used to generate content provided to users, the AI/ML models are generally not relied on to generate the facts or values. Instead, the AI/ML models can be used primarily to prioritize, organize, and assess the relevance of facts and values that are accurately and deterministically generated by the database systems or other systems.

In one general aspect, a method includes: providing, by a computing device, a user interface of the computing device and one or more modules configured to present a feed of information cards that is updated over time, wherein the feed includes information cards selected for a particular user from one or more channels associated with the particular user, wherein the one or more modules are configured to update the feed with information cards are selected based at least in part on a context of the computing device that includes content of the user interface; determining, by the computing device, the content of the user interface of the computing device; providing, by the computing device, data indicating the content of the user interface to a server system over a communication network; receiving, by the computing device, data from the server system that indicates content of one or more information cards selected based on the content of the user interface from the one or more channels associated with the particular user; and updating, by the computing device, the feed to include the one or more information cards indicated by the received data.

In some implementations, the set of information cards in the feed is updated based on a change in the content of the user interface.

In some implementations, the set of information cards is updated based on a change in content of a data set associated with one or more channels associated with the user.

In some implementations, the set of information cards is updated based on an event from a third-party system that is detected by the server system.

In some implementations, the feed is configured to receive information cards from a plurality of channels, wherein each of the channels is configured to provide information cards based on records of one or more corresponding data sources, and wherein the plurality of channels includes channels that provide cards based on different data sources.

In some implementations, each of the plurality of channels is configured to provide information cards for each of a set of information card types, and different channels are configured to provide information cards from different sets of information card types; and, for each of the channels, the information card types each have a stored set of criteria that specifies when an information card of the information card type is generated.

In some implementations, the feed is configured to provide a dynamically updated set of information cards that is personalized for the particular user, including by progressively adding information cards to the feed based on content of the user interface of the computing device and a history of interactions of the particular user with information cards presented in the feed.

In some implementations, the feed is configured to selectively present a subset of information cards available from the plurality of channels associated with the particular user, wherein the information cards are selected based on ranking or filtering according to relevance of the information cards to the content of the user interface, and wherein the selection is repeatedly updated by inserting new information cards that increase in relevance in response to changes in the content of the user interface.

In some implementations, selection of information cards to present in the feed is based at least in part on an application in the user interface, a web page displayed in the user interface, or text of the user interface.

In some implementations, the types of information cards or the content of the information cards is context-dependent such that, for different users and from the same channel, a same keyword or entity can result in different information card content being presented to the different users, based on one or more of surrounding content of the user interface, a history of interactions of the user, a role of the user, a task of the user, or records in a data set.

In some implementations, the feed is configured to present information cards that include links or other interactive controls configured to respond to user interaction by initiating actions or prompting access to interfaces associated with the information card content.

In some implementations, the feed is configured to present information cards triggered for presentation based on a schedule, a threshold, a contextual match, or an event from a third-party system.

In some implementations, the feed is configured to present information cards generated to include content generated by a large language model.

In some implementations, one or more of the information cards is generated based on (i) a predetermined template for a card type indicating a format for an information card and (ii) retrieved information selected from a data set based on a keyword or other information from the content of the user interface, wherein the large language model is used to generate text items according to the predetermined template based on the retrieved information selected from the data set.

In some implementations, the information cards include one or more information cards that each correspond to a different record or event from a third-party system.

In some implementations, the one or more modules is configured to provide a chatbot interface, wherein the chatbot interface is configured to receive information from the information cards in the feed as context to answer questions entered in the chatbot interface.

In some implementations, the chatbot interface provides access to a chatbot having access to underlying data sets referenced by the information cards, such that the chatbot is configured to answer questions relating to the topics indicated in the information cards using information from the data sets that is not included in the information cards.

In some implementations, the feed is configured to provide information cards that, for each new information card inserted into the feed, are limited based on personalized filtering and prioritization for the particular user of the information cards available from the one or more channels.

In another general aspect, a method performed by one or more computers includes: storing, by the one or more computers, (i) channel selection data that indicates associations of users with the channels, and (ii) channel data for the channels that indicates, for each of the channels, information card types, data sources providing information for generating information cards, and criteria for presenting information cards for the information card types; receiving, by the one or more computers, data indicating content of a user interface of a computing device of a particular user over a communication network; identifying, by the one or more computers, a set of the channels for the particular user based on the channel selection data; determining, by the one or more computers, a set of information cards available from the identified set of channels; selecting, by the one or more computers, a subset of the information cards in the identified set, wherein the subset is selected based on a measure of relevance with respect to the received data indicating the content of the user interface; generating, by the one or more computers, data for the subset of the information cards based on the data sources indicated in the channel data; and transmitting, by the one or more computers, the generated data for the subset of the information cards to the computing device over the communication network.

In some implementations, selecting the subset of the information cards comprises filtering the set of the information cards based on content of the user interface.

In some implementations, selecting the subset of the information cards comprises ranking the information cards in the set and selecting a top-ranking portion of the information cards as the subset.

In some implementations, selecting the subset of the information cards comprises enforcing a minimum threshold of relevance for information cards, such that information cards having a relevance measure below the minimum threshold are excluded from the subset.

In some implementations, the method includes: monitoring the data sources to detect conditions that satisfy the criteria for presenting information cards indicated by the channel data; detecting that the criteria for presenting an information card for a particular information card type has been satisfied; and in response to detecting that the criteria for presenting the information card for the particular information card type has been satisfied, generating and transmitting data for the information card to the computing device over the communication network.

In some implementations, detecting that the criteria for presenting the information card for the particular information card type has been satisfied comprises at least one of: determining that current time satisfies a timing condition; determining that a record has changed; determining that a status of an object or data item has changed; determining that a score for priority or urgency satisfies a minimum threshold; determining that a value in a data set satisfies a predetermined threshold; determining that a value in a data set has changed by an amount that satisfies a predetermined threshold; or receiving a message indicating an event that occurred in a third-party system.

In some implementations, the method includes providing a personalized combination of information cards selected for the particular user as a subset of information cards available from among multiple channels that the particular user is subscribed to or is associated with.

In some implementations, the method includes providing personalized feeds of information cards to multiple members of an organization through a software-as-a-service platform, wherein each of the members of the organization receive a personalized selection of information cards selected from channels managed by the organization, and wherein, for each of the members of the organization, the feed is personalized based on (i) a context of a user device of the member of the organization and (ii) one or more interactions of the member of the organization with previously presented information cards.

In some implementations, the method includes providing a management interface that includes functionality to adjust the channels provided, the information card types provided for the channels, the data sources providing information for generating information cards from the channels, and criteria for presenting information cards for the information card types.

In some implementations, the method includes generating and transmitting an additional information card to be inserted into a feed for the particular user in response to a change in content of the user interface of the computing device of the particular user.

In some implementations, the method includes generating and transmitting an additional information card to be inserted into a feed for the particular user in response to a change in content of a data set associated with one or more channels associated with the particular user.

In some implementations, the method includes generating and transmitting an additional information card to be inserted into a feed for the particular user in response to an event from a third-party system.

In some implementations, the method includes providing information cards at different times for a feed of the particular user, wherein the information cards are generated from a plurality of channels, wherein each of the channels is configured to provide information cards based on records of one or more corresponding data sources, and wherein the plurality of channels includes channels that provide cards based on different data sources.

In some implementations, each of the plurality of channels is configured to provide information cards for each of a set of information card types, and different channels are configured to provide information cards from different sets of information card types; and, for each of the channels, the information card types each have a stored set of criteria that specifies when an information card of the information card type is generated.

In some implementations, the feed is configured to provide a dynamically updated set of information cards that is personalized for the particular user, including by progressively adding information cards to the feed based on content of the user interface of the computing device and a history of interactions of the particular user with information cards presented in the feed.

In some implementations, the feed is configured to selectively present a subset of information cards available from the plurality of channels associated with the particular user, wherein the information cards are selected based on ranking or filtering according to relevance of the information cards to the content of the user interface, and wherein the selection is repeatedly updated by inserting new information cards that increase in relevance in response to changes in the content of the user interface.

In some implementations, a selection of information cards to present in a feed of the particular user is based at least in part on an application in the user interface, a web page displayed in the user interface, or text of the user interface.

In some implementations, the types of information cards or the content of the information cards is context-dependent such that, for different users and from the same channel, a same keyword or entity can result in different information card content being presented to the different users, based on one or more of surrounding content of the user interface, a history of interactions of the user, a role of the user, a task of the user, or records in a data set.

In some implementations, a feed for the particular user is configured to present information cards that include links or other interactive controls configured to respond to user interaction by initiating actions or prompting access to interfaces associated with the information card content.

In some implementations, the criteria for presenting the information cards includes triggers based on a schedule, a threshold, a contextual match, or an event from a third-party system, and wherein the one or more computers are configured to monitor for conditions that trigger presentation of the information cards for each of multiple users.

In some implementations, generating data for the subset of the information cards based on the data sources indicated in the channel data comprises generating content of an information card using a large language model.

In some implementations, one or more of the information cards is generated based on (i) a predetermined template for a card type indicating a format for an information card and (ii) retrieved information selected from a data set based on a keyword or other information from the content of the user interface, wherein the large language model is used to generate text items according to the predetermined template based on the retrieved information selected from the data set.

In some implementations, the method includes using an artificial intelligence or machine learning (AI/ML) model to determine criteria for presenting an information card to one or more users; storing the determine criteria in associating with a particular information card type; and using the stored criteria to determine when to generate or transmit information cards of the particular information card type.

In some implementations, the method includes: receiving a user prompt through a chatbot interface associated with a feed that presents the information cards for the particular user; providing, as input to an artificial intelligence or machine learning (AI/ML) model, (i) the user prompt and (ii) context comprising content of information cards in a feed of the particular user; and providing, as a response to the user prompt, a response based on output that the AI/ML model generated in response to the user prompt and the context comprising the content of the information cards.

In some implementations, the context comprises additional information including one or more of: content from the user interface of the computing device of the particular user; content selected from one or more data sets referenced by the information cards in the feed of the particular user, including information from the data sets that is not included in the information cards; or a data model or data schema for the one or more data sets referenced by the information cards in the feed of the particular user.

In some implementations, the method includes providing information cards for presentation in a feed for the particular user that is limited based on personalized filtering and prioritization for the particular user of the information cards available from one or more channels to which the particular user is subscribed or associated.

Other embodiments of these and other aspects described herein include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

In another general aspect, a method performed by one or more computers includes: providing, by the one or more computers, an interface configured to create or edit a channel to provide information cards over a communication network for presentation by user devices, wherein the channel is configured to provide information cards to the user devices selectively based on the respective contexts of the user devices; receiving, by the one or more computers, input through the interface, wherein the input indicates one or more data sources; establishing, by the one or more computers, a connection to the one or more data sources indicated by the input and generating data indicating characteristics of the one or more data sources; receiving, by the one or more computers, data through the interface that designates one or more information card templates to be provided to through the channel; and configuring, by the one or more computers, the channel to provide information cards based on the one or more information card templates selectively to users, wherein the information cards are populated based on keywords or topics from the one or more data sources and are triggered for presentation on the user devices based on the respective contexts of the user devices.

In some implementations, generating the data indicating the characteristics of the one or more data sources includes generating a data model for the one or more data sources, wherein the data model indicates types of data objects available in the one or more data sources. The method includes using the data model to select data from the one or more data sources and populate the one or more information card templates.

In some implementations, the one or more computers are configured to trigger presentation of information cards based on criteria including a schedule, a threshold, a contextual match, a change in data in the one or more data sources, or an event from a third-party system.

In some implementations, the one or more computers are configured to separately monitor for conditions that trigger presentation of information cards for each of multiple users.

In some implementations, the multiple different information card templates are associated with the channel, and wherein information cards for a first information card template are triggered based on a schedule, and wherein information cards for a second information card template are triggered based on application of a value from the one or more data sources satisfying a threshold.

In some implementations, the interface is configured to receive indications of criteria for presenting information cards for each of multiple different information card templates. The method includes: receiving, through the interface, input that specifies different criteria for different information card templates; and storing the criteria for the respective information card templates; and presenting information cards on the client devices according to the associated criteria.

In some implementations, generating the data indicating the characteristics of the one or more data sources includes: extracting, from the one or more data sources, data including a data schema, labels or names for data objects, or sample data; providing the extracted data to one or more artificial intelligence or machine learning (AI/ML) models; using the one or more AI/ML models to (i) identify first data objects available from the one or more data sources and (ii) correlate the first data objects with second data objects to determine relationships between the first data objects and the second data objects; storing at least some of the relationships determined using the one or more AI/ML models in a data model; and using the data model to populate fields of the one or more information card templates with information from the one or more data sources to provide information cards to the client devices.

In some implementations, the method includes providing information describing the one or more information cards and the one or more data sources to one or more artificial intelligence or machine learning (AI/ML) models; obtaining, from the one or more AI/ML models, output that indicates criteria for triggering display of information cards from the one or more information card templates; storing the criteria in association with the one or more information card templates and repeatedly determining whether the criteria are satisfied for each of multiple client devices; and in response to determining that the criteria are satisfied for a particular information card template for a particular client device, providing an information card based on the particular information card template for a particular topic or keyword determined based on a context of the particular client device.

In some implementations, the method includes using one or more artificial intelligence or machine learning (AI/ML) models to evaluate when to provide information cards to be presented by the client devices, including: performing retrieval-augmented generation (RAG) over information from the one or more data sources to identify portions of data from the one or more data set that are relevant to a context of a particular client device; generating, using the AI/ML models, content of one or more information cards for the particular client device based on the identified portions of the data; and providing, to the particular client device, the generated content of the one or more information cards for display.

In some implementations, the method includes after establishing the connection to the one or more data sources, detecting a change in a data item in a first data source; in response to detecting the change in the data item, performing a search to identify a second data item, in a second data source, that has a predetermined relationship with to the changed data item; and using the first data item from the first data source and the second data item from the second data source to generated an information card for presentation at one or more of the client devices.

In some implementations, the method includes providing, in the interface, interactive controls configured to set or change which information card templates are associated with each of different channels; receiving data indicating user input specifying an assignment of users to channels; saving data indicating the assignments of users to channels; and generating and providing information cards from the information card templates based on the assignments, including by populating information card templates with data based on (i) one or more triggers being detected, and (ii) templates being populated topics or keywords detected in the contexts of the client devices.

In some implementations, the method includes providing, in the interface, interactive controls configured to set or change which users are associated with different channels; receiving data indicating user input specifying an assignment of users to channels; saving the assignments of users to channels; and generating and providing information cards to the client devices based on the assignments.

In some implementations, the method includes providing a personalized stream of information cards to each of multiple individual users, wherein the stream of information cards for each user is based on a combination of channels that the user is associated with, wherein providing each stream of information cards includes: generating information cards from information card templates according to contextual items determined for the client device of the user; and prioritizing the set of generated information cards, from across the combination of channels associated with the user, to provide a set of highest-relevance cards to the user.

In some implementations, the method includes: providing one or more information cards for a user to be cached at a client device for the user, wherein the one or more information cards are designated to be held in reserve for future display in response to a user event; after occurrence of the user event, receiving a message provided in response to the user event; in response to receiving the message, and while the one or more cached information cards are displayed at the client device for the user, determining one or more additional information cards to provide for the user based on a current context of the user or the client device of the user; and providing the one or more additional information cards to the client device of the user.

In some implementations, the user event is a user action to log in to an application or web interface providing access to the channel, or a user action to open or bring into view a user interface providing access to the channel.

In some implementations, the method includes tagging or marking a first set of information cards to be maintained in reserve for future display in response to a user event, wherein the first set of information cards is selected based on a different set of criteria than information cards selected to be provided in response to context of the client devices.

In some implementations, cards that are cached are selected for this use using a different ranking or prioritization calculation. One set of criteria may be used for selecting information cards for contextual display, and another set of criteria may be used for cached cards that weights priority factors differently in view of intended display when current context is not known.

In some implementations, the method includes providing, through the interface, data indicating assignments of users to channels and adjusting the assignments of users to the channels based on input through the interface.

In some implementations, the one or more data sources comprise at least one of a file, a data set, a database, a data cube, or a third-party system or service.

In some implementations, generating the data indicating the characteristics of the one or more data sources includes generating a data model that (i) identifies data objects, attributes, and metrics that can be derived from the one or more data sources, and (ii) identifies connections among multiple data sources.

In some implementations, the method includes obtaining telemetry data for users, wherein the telemetry data indicates at least one of applications used, web domains visited, or elements of web pages are frequently used.

In some implementations, the method includes obtaining user interaction data for users, wherein the user interaction data indicates user selections of information cards, dismissals of information cards, time that information cards are visible or viewed;

In some implementations, the method includes using the user interaction data to determine, for each individual user, which types of information cards and elements of the information cards the user consumes most; and using information derived from the user interaction data to personalize, for each user, the information cards selected and/or criteria for triggering display of information cards.

In some implementations, the method includes maintaining a data store for each user indicating contexts of one or more client devices of the user; and using the data store indicating contexts of the users to select information cards for the respective users.

In some implementations, the user interaction data includes usage data and user interaction data of the users from third-party platforms, wherein the one or more computers obtain the usage data and interaction data through one or more application programming interfaces (APIs) of the third-party platforms.

In some implementations, the method includes learning from telemetry data and user interaction data to adjust the ranking and relevance of information cards, both generally and with respect to particular topics or keywords.

In some implementations, the method includes applying one or more artificial intelligence or machine learning (AI/ML) models to the telemetry data or user interaction data, for an individual user or a group of users, to obtain from the AI/ML models at least one of (i) customized criteria, determined based on the telemetry data or user interaction data, for triggering presentation of one or more information cards, or (ii) customized information card content determined based on the telemetry data or user interaction data.

In some implementations, the context of a client device includes (i) information presented in a user interface (e.g., on screen, or in a pane although scrolled off or not currently visible) and (ii) stored data linked to the items on the screen.

In some implementations, the context of a client device of a user includes content of emails of the user or content of calendar appointments of the user (e.g., message senders, message recipients, meeting participants, times, keywords, message body text, message subject text, whether attachments are included, etc.).

In some implementations, the method includes evaluating relevance of multiple information card options for each user, based on historical information about the user (e.g., telemetry data, user interaction data, user interaction with previous information cards); and selecting information cards for each user based on the relevance determination (e.g., potentially generating relevance scores or priority scores) determined for the user.

In some implementations, the method includes adjusting historical information or context information to weight it based on recency, such that increasing age of items results in decreasing relevance to the user.

In some implementations, the method includes identifying connections among multiple sources of context, including two or more of a current user interface, a previous user interface, user interactions, calendar items, a contacts list, a call history, records in other systems (e.g., CRM, ERP, etc.), wherein connections identified among the multiple sources of context combine to boost a relevance score or priority of information cards corresponding to one or more of the connected items.

In some implementations, the method includes varying, over time, a weighting of parameters used in calculation of relevance of the information cards, for individual users or for groups of users, based on user interaction with information cards over time.

In some implementations, the method includes: learning, by the one or more computers, specific data filters for subsets of information from the one or more data sets, wherein the specific data filters correspond to events or entities; and defining card templates corresponding to the learned data filters to facilitate display of information cards for the events or entities.

In some implementations, the method includes providing to a particular user a stream of multiple information cards provided sequentially in a user information card feed, in which multiple information cards are shown concurrently, ordered in sequence.

In some implementations, the information cards in the stream include information cards presented asynchronously with respect to user actions on the user interface, and at least some of the information cards are not presented in response to user interaction with content or keywords in the user interface.

In some implementations, the method includes providing, in the user interface, an interactive list of data objects from one or more data sources or data models, where the interactive list includes items corresponding to the data objects that are selectable to add or insert fields corresponding to the data objects into an editable text field that specifies content for an information card template.

In some implementations, the fields represent different data objects from a data model that describes data from multiple different data sources, such that an information card template can include fields representing data taken from each of the multiple different data sources.

In some implementations, the interface is a user interface that includes second interactive controls configured to receive user input to specify criteria to trigger presentation of an information card based on the first information card template.

In some implementations, the second interactive controls are configured to trigger presentation of an information card based on a time condition, including repeatedly providing versions of an information card based on a schedule.

In some implementations, the second interactive controls are configured to define characteristics of an event, such that occurrence of an event with the specified characteristics triggers presentation of an information card based on the first information card template.

In some implementations, the second interactive controls are configured to define a condition based on user input, such that occurrence of the condition triggers presentation of an information card based on the first information card template.

In some implementations, the condition includes at least one of a number of items in a category satisfies a threshold, a value of a data object satisfying a threshold, a change in a value or status occurs, or a magnitude of a change of a value satisfies a threshold.

In some implementations, the interface includes a user interface having third interactive controls configured to set user-specified filter conditions to apply for generating values from one or more data sets or data sources for (i) populating fields of the first information card template or (ii) determining whether the one or more criteria for presenting an information card based on the first information card template have been satisfied.

In some implementations, the third interactive controls are configured to specify conditions that restrict portions of data used by specifying a value or range for at least one of a time, a category, a location, a priority level, an amount of items, or a magnitude of a value.

In some implementations, where the method includes providing information describing content of the first information card template to one or more artificial intelligence or machine learning (AI/ML) models, the provided information including the first user input; obtaining, from the one or more AI/ML models, output that indicates one or more candidate criteria for triggering display of information cards based on the first information card template; and providing the one or more candidate criteria for display in the interface.

In some implementations, the one or more AI/ML models comprise a large language model (LLM); and providing the one or more candidate criteria for display in the interface includes at least one of providing the one or more candidate criteria in a chatbot interface, changing settings of one or more user interface controls of the interface to provide the one or more candidate criteria, or providing a selectable option that is selectable by the user to apply the one or more candidate criteria.

In some implementations, the one or more AI/ML models are provided historical information indicating previous user interactions with previous information cards, and where the output that indicates the one or more candidate criteria is generated based at least in part on the previous user interactions.

In some implementations, the one or more AI/ML models are provided historical information indicating previous user interactions with previous information cards, timing of the user interactions, and context data for client devices corresponding to the previous user interactions; and the output that indicates the one or more candidate criteria is generated based at least in part on the previous user interactions, the timing of the user interactions, and the context data corresponding to the previous user interactions.

In some implementations, the interface includes a chatbot interface including a text field for a user to submit text prompts including instructions to the chatbot to create or edit information card templates. The method includes: in response to a user prompt entered in the chatbot interface, obtaining from one or more artificial intelligence or machine learning (AI/ML) models, output indicating at least one of content for the first information card template, one or more fields to provide data from a data source in information cards generated by the first information card template, or one or more criteria for triggering presentation of an information card based on the first information card template; and updating the interface to update the information card template based on the output of the one or more AI/ML models, including at least one of setting a state or value of user interface controls based on the output of the one or more AI/ML models or changing an information card preview or layout for the first information card template.

In some implementations, the one or more AI/ML models generate the output based on processing input that indicates at least one of (i) content of existing information card templates or example information cards, (ii) a data model describing data objects available to be used in information cards, or (iii) user interaction data indicating a log or description of user interactions with information cards.

In some implementations, the method includes applying one or more artificial intelligence or machine learning (AI/ML) models to telemetry data or user interaction data, for an individual user or a group of users, to obtain from the one or more AI/ML models at least one of (i) customized criteria, determined based on the telemetry data or user interaction data, for triggering presentation of one or more information cards, or (ii) customized information card content determined based on the telemetry data or user interaction data.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1B are diagrams that show an example of a system for context-driven information delivery assisted by artificial intelligence.

FIGS. 2A-2B and 3A-3C are diagrams that show examples of user interfaces providing information based on the context of the user.

FIG. 4 is a diagram that shows an example of information provided about a particular entity.

FIGS. 5A-5B are diagrams that show examples of user interface for changing settings for providing information to a user.

FIGS. 6A-6F are diagrams that show examples of information cards.

FIGS. 7A-7E are diagrams that show examples of user interfaces for configuring data sources to provide data from various sources through customized information channels.

FIGS. 8A-8D are diagrams that show examples of user interfaces for configuring properties of information channels.

FIG. 9A is a diagram showing an example user interface that shows information about information cards and feedback from users.

FIG. 9B is a diagram showing an example user interface that shows a stream view for a user.

FIG. 10A is a diagram showing an example of a user interface for designing information cards.

FIG. 10B is a diagram showing an example list of operators for defining conditions to trigger presentation of information cards.

FIGS. 10C, 11A, and 12A are diagrams showing examples of information card templates.

FIGS. 10D, 11B, and 12B are diagrams showing examples of information card instances created based on the respective information card templates of FIGS. 10C, 11A, and 12A.

FIG. 13 is a diagram showing an example user interface showing information card templates and corresponding trigger conditions.

Like reference numbers and designations in the various drawings indicate like elements.

### DETAILED DESCRIPTION

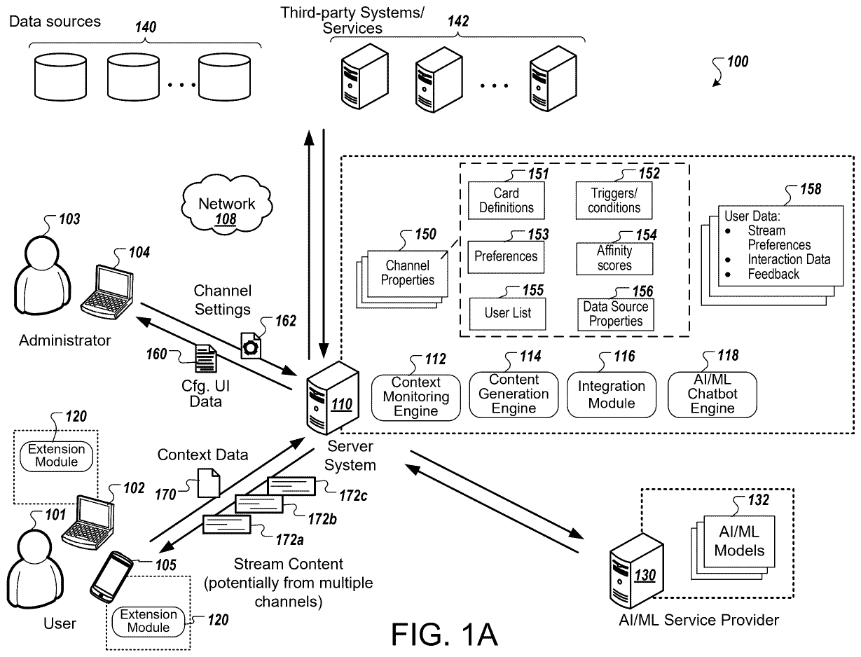

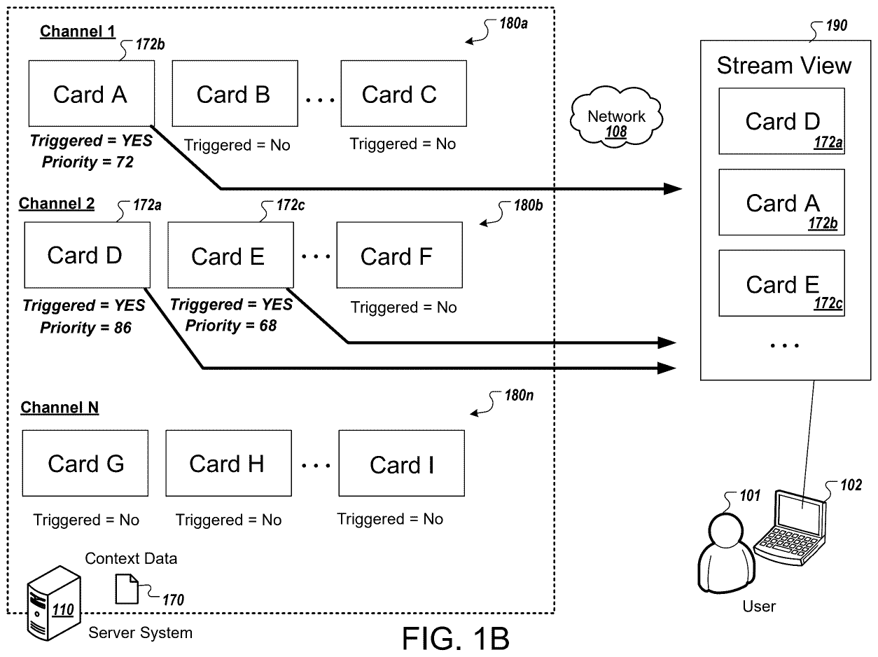

FIGS. 1A-1B are diagrams that show an example of a system 100 for context-driven information delivery assisted by artificial intelligence. The system 100 includes a server system 110, an AI/ML service 130, an administrator device 104, and user devices 102, 105. The various devices communicate over a network 108, such as the Internet. In the example, the server system 110 communicates with various data sources 140 and third-party systems or services 142 to obtain information, analyze the information, and selectively provide information to users that is relevant to their current context. In the system 100, user devices 102, 105 send context data 170 to the server system 110, such as text in the current user interface view or current application displayed to the user. The server system 110 uses the channels of content that administrators have defined to determine which pieces of information are most relevant to the users' context, and then sends stream content 172a-172c, which can be information cards, visualizations, and other items.

Each user can be provided a customized, dynamic stream of content that is selected and updated based on the user's current context, as well as the user's preferences and history of interactions. In many cases, a user's stream can represent the a combined or integrated feed of information from multiple different channels, with the information that is surfaced to a user being selected and ranked according to what is predicted to be most useful to the user in the current context. Items in a stream can be selected or triggered for display based on various factors. In some cases, the user's application (e.g., web browser, document editor, etc.) includes the name of an entity (e.g., a company, a person, a product, etc.), and so the system determines that information about that entity is useful. In other cases, information is selected for presentation to the user based on time or location, such as indicating information related to an upcoming meeting or to a location of the user. The types of information presented in a stream, and the conditions in which those types of information are surfaced or triggered for presentation, can be set by an administrator, determined by AI/ML models 132, or set or adjusted by the user.

In further detail, the server system 110 coordinates and manages the interactions in the system 100. The server system 110 provides a platform in which various different companies or other organizations can define channels of information to provide to their users. The server system 110 provides an interface to administrators of various companies or organizations so that they can create and manage their channels and user groups. For example, the server system 110 can provide an interface, such as an application programming interface (API), a web page, a web application, data for a native application, and so on. The illustrated example shows an administrator 103 and an administrator's device 104. The server system 110 provides configuration user interface data 160, such as a web-based portal for creating and managing channels of information and user groups. The administrator 103 adjusts settings and specifies the properties to be used, and the administrators device 104 sends the channel settings 162 to the server system 110 over the network 108.

The administrator 103 can specify many different properties of the information channels. For example, the administrator one of three can specify one or more data sources 140 from which the channel draws information to present to users. These data sources 140 can include structured data sets, databases, spreadsheets, unstructured data, data cubes, data repositories, data warehouses, and so on. The data source is 140 may be stored locally at the server system 110, or in on premises servers of the administrators organization, or in cloud computing platforms, or other computing systems.

The administrator 103 can also specify integration with third party systems and services 142, each of which may provide their own data sets and information. For example, a variety of application providers, website providers, messaging services, social media companies, office productivity vendors, CRM product vendors, and others can make their data available through APIs. The administrator one of three can set up connections with preferred third party systems and services 142 and can specify account information or authentication information so that the server system 110 can interact with the third party systems and services 142 as needed. This can include periodic checks for changes in status, for receiving events from the third party systems or services 142, on demand requests for information by the server system 110 when certain types of information cards are triggered for presentation, and so on.

The administrator one of three is able to define sets of information to be provided through different channels. For example, a first channel can be configured to provide information from one data set, a second channel can be configured to provide information from another data set, and so on. Similarly, the administrator 103 can define the channels in terms of topics, so that a first channel relates to a first topic (e.g., sales information) across multiple data sources 140 or third party systems and services 142, and the second channel relates to a second topic (e.g., product design) across the same or different data sources 140 and 3rd party systems and services 142. This gives the administrator the versatility to define the prop ladies of each channel separately, and then to assign or invite different sets of users to different channels. Then, after users join or subscribe to different channels, each user's personalized information stream will be composed of the types of information from the user's set of channels, with presentation behavior further being customized based on the user's context.

The server system 110 stores a set of channel properties 150 for each channel that is defined. The server system 110 can store information about the channels of many different companies or organizations, and each company or organization can have multiple channels defined. The channel properties 150 for a channel can include various types of information that affect the selection and presentation of information from that channel to users. For example, the channel properties 150 can include card definitions 151, such as templates or specifications that specify the content, format, layout, etc. for different information cards. As an example, a card definition can include text to display, formatting information, and fields to be populated with information from a data set 140 or from a third party system or service 142. The card definition can specify the source of the data, the particular values for data objects to use in populating fields, links or interactive controls to include in the information card, icons, visualizations, or other graphics, and so on.

The channel properties can also include triggers or conditions 152 corresponding to the card definitions 151. For example, for each type of information card, one or more triggers or conditions 152 can be specified to provide the criteria that the system 110 applies to determine when the corresponding card should be presented. The triggers and conditions can be based on one or more factors, such as presence of the keyword in a user interface, a time or date, a change to a record, a value in a certain range or reaching a particular threshold, and so on. Some types of information cards can be set to be provided on a schedule, such as daily, weekly, monthly, and so on. Others can be based on a timing reference, such as an hour or a day before a scheduled meeting, or a day or another amount of time before a deadline, and so on. Other triggers and conditions 152 may specify that a company name in the current user interface triggers presentation of the card. In other cases the trigger or condition can be a metric or value changing by at least a predetermined amount (e.g., 10%, 20%, etc.), or reaching a predetermined threshold level, or entering or exiting a predetermined range. Other triggers and conditions can be based on data or actions of a third party, such as to trigger an information card when a value in a database changes, or when a third party system or service 142 indicates that a particular event has occurred. The triggers and conditions 152 can include complex or compound triggers, which may cause a particular information card to be triggered when any of multiple different conditions occur or potentially when a combination of multiple conditions occur together.

The triggers and conditions 152 can be set in various different ways. For example, the administrator 103 can manually specify a trigger or condition 152 for a card in other cases, the server system 110 can provide user activity data showing how users have access data or used applications over time, and the system 110 can ask the AI/ML models 132 to extract patterns and indicate a set of conditions that are predicted to show when the information in a particular information card is relevant. The administrator 103 can view and edit triggers or conditions generated by the AI/ML models 132. In addition, as information cards are presented to users, the users can provide feedback that can reward or penalize the presentation of information cards which the server system 110 can use to alter the triggers or conditions 152 for the corresponding cards, along with the relevance measures and priority for those cards. In some cases, users may manually specified their own triggers and conditions 152 to customize the behavior of the system and the content of the user's own information stream.

The channel properties 150 also include preferences 153 or settings for the channel as specified by the administrator 103. The channel properties 150 also include affinity scores 154 for the channel, which can assist in determining the relevance or level of association of different information cards and contexts. For example, the affinity scores 154 can include measures of the applicability of certain information cards, topics, and types of information with various user types, user roles, situations, and context elements. The server system 110 can set the affinity scores 154 and adjust them overtime based on user feedback and other factors. The channel properties 150 can include a user list 155 for the channel, which can indicate the specific users or groups of users that are authorized to receive information from the channel or have then subscribed or connected to the channel. The channel properties 150 can include data source properties 156 for the channel, which can include an indication of which data sources 140 are accessed, which third party services or systems 142 provide data, authentication information or account information for accessing data, and other settings to obtain the data needed to provide information in the channel.

The server system 110 also stores user data 158, which can include a separate set of data about each user and their personalized stream. For example, the user data 158 for a user can include stream preferences of the user, such as user-specific settings for the amount, type, and frequency of information and the form in which it is presented. The user data 158 can include interaction data for a user, such as a record of which information cards presented to the user were interacted with and which were not, as well as the contexts present, the type of interaction, the duration of interaction, whether the information card was actively dismissed by the user or was ignored, and so on. The user data 158 can also include user feedback from the user, such as ratings (e.g., a thumbs up rating, thumbs down rating, a score such as 3 out of 5, etc.). The user data 158 can also include a list of the channels that the user has subscribed to or connected to, which are active in providing content for the user's stream. In general, the user data 158 can be stored at the level of the user stream, which may combine information from multiple channels.

The server system 110 includes various modules or processing engines that can operate to generate the content of the streams for users. For example, the server system 110 can include a context monitoring engine 112 that is configured to receive and process context data from user devices 102, 105. The context monitoring engine 112 is configured to evaluate criteria of the triggers and conditions 152 repeatedly over time, to detect when each user's context satisfies the criteria for information cards of the channels the user is connected to. When the trigger or condition 152 for an information card is satisfied by a user's context data 170, this indicates that the information card is appropriate to be displayed, and the server system 110 performs further processing.

The server system 110 can evaluate or rank the relevance of information cards that are triggered for presentation to a user. Although satisfying the trigger or condition for a information card indicates that the information card is relevant and appropriate for the user, there may be multiple information cards available and triggered for presentation to the user, and the user interface may only permit a limited number (e.g., 3-5) of information cards to be viewed at a time. In addition, it is still important to measure the importance or relevance of triggered information cards so the server system 110 can rank or prioritize the information cards for the user 101.

In some implementations, the server system 110 determines a relevance score for each triggered card based on the context data 170 indicating the current context. This can be done based on metadata or information in the card definitions 151, even before the information is generated, to improve efficiency so that only the most relevant information cards are actually generated. In other cases, the information cards can be generated and then evaluated for relevance to rank or prioritize them for presentation in the user's stream.

The server system 110 can use various techniques to minimize latency and improve efficiency. For example, the server system 110 can be configured to perform at least some analysis and content generation steps based on a stream view area being displayed or in response to user interaction. The user devices 102, 105 can inform the server system 110 when the user devices 102, 105 are active, and thus when the user 101 is able to receive information in a stream. The server system 110 can limit evaluation of triggers and conditions 152 for a user (e.g., for the information cards in the channels the user 101 is connected to) to times when the user devices 102, 105 are active and providing context data 170, to avoid updating the stream when the user will not see the results. When a user device 102, 105 is active, the server system 110 can provide information indicating when one or more information cards are available, which can be presented on the user device 102, 105 as an icon or other indicator that stream content is available. When the user 101 interacts with the icon or otherwise opens a user interface area for the stream, the user device 102, 105 notifies the server system 110 and the server system 110 responds by generating available cards 172a-172c as stream content. As a result, the generation of information cards, and in some cases the analysis of triggers and conditions also, can be performed just-in-time in response to the user device 102, 105 reaching a state where the user 101 can select or view the information cards.

The server system 110 can manage the information cards and channels in other ways also. For example, in some implementations, the server system 110 generates and stores information cards for each channel based on the card definitions 151 and triggers and conditions 152, where the triggers and conditions 152 for creating a card may not be based specifically on the user context but on other factors. For example, some cards can be generated based on the underlying datasets, such as a metric increasing by at least 20% or status value changing. The server system 110 can create information cards based on these conditions, and then hold them in reserve for relevance to be assessed for individual users. In this case, there is an ongoing flow of new information cards triggered and created for each channel, and the context information 170 is used primarily to determine relevance and select information cards out of the group of cards for the channels, not necessarily to trigger the generation of information cards. Other information cards, such as those based on a user's own personal calendar data or other user data can also be generated by the service system 110 and saved until their relevance or priority scores are sufficient to surface them in the user's information stream.

To minimize latency, in some implementations, the server system 110 can periodically generate and provide information cards to the user device 102 that can be stored locally at the user device 102 and can be presented very quickly when the user acts to view the stream. For example, information cards about upcoming meetings, scheduled events or deadlines, news, frequently-viewed items, and so on can be generated and cached locally at the user device 102, to be initially displayed with minimal delay when a user opens a stream viewing interface (e.g., a sidebar, a web browser window, etc.). Then, in response to the opening of the stream viewing interface, the server system 110 can generate and send a refreshed set of information cards that are targeted to the current context of the user, including information cards selected based on the contents of the current user interface of the user device 102.

The server system 110 includes a content generation engine 114 that is configured to generate the content of the information streams for users. Of the information cards that have triggers or conditions 152 satisfied for a user's stream, the content generation engine 114 can generate the information cards that are in the highest-ranking portion (e.g., top 5, top 10, top 15, etc.). Once the highest ranking or most relevant set of information cards is identified, content generation engine 114 uses the card definitions 151 and the context data 170 to create the actual information cards 172a-172c.

For example, the user interface of the user device 102 can include the name of a product, and the trigger or condition 152 for a particular card definition 151 can specify that the presence of a product name triggers presentation of the information card. The content generation engine 114 then creates the actual information card data to be displayed. The card definition 151 indicates the types of information that need to be inserted into the card, as well as the data sources 140 or third party systems and services 142 that the data needs to be retrieved from. The server system 110 can retrieve or query for the types of information needed, specifically for the particular product that is referenced on the user interface of the user device 102. The content generation engine 114 then populates the retrieved information into the template or output format specified by the card definition 151 to create the information card 172a that is sent to the user device 102. In some cases, generating the information card 172a can include populating fields in a template, or otherwise inserting information about an entity or topic referenced in the context data 170. In other cases, an information card may be assembled based on other instructions, such as to retrieve document names, appointment records, e-mail subject lines, or other items that meet certain criteria, whether that is based on keywords, topics, time and date criteria, or other factors. In some cases, an information card may involve summarizing or interpreting a set of content, and the content generation engine 114 can leverage the AI/ML models 132 to generate that content. For example, a card definition 151 may include (1) a set of instructions for an AI/ML model 132, such as to create a summary or to describe a relationship, and (2) information describing a particular data set or set of results to be analyzed (e.g., by specifying a data aggregation or SQL statement to define a subset of data). In this case, the content generation engine 114 can formulate a request to the AI/ML models 132 based on the card definition 151 and a set of data from a database or other data source 140 or a third party system or service 142. The output of the A/ML models 132 can provide the content for an information card 172a-172c.

To facilitate integration of the platform with third party systems and services 142, the server system 110 can include an integration module 116 that handles communication with and authentication with the third party systems and services 142. For example, the integration module 116 can track and manage the collection of data from the third party systems and services 142, as well as receive and handle notifications of events that the third party systems and services 142 send to the server system 110. Detected events and changes in data from the third party systems and services 142 can then be processed by the context monitoring engine 112 to determine if they and satisfy triggers and conditions 152 for the information cards of various channels.

In some implementations, the stream management platform is integrated with one or more AI/ML chatbots, so that users can ask a chatbot questions about information cards 172a-172c or their corresponding data sets. The server system 110 can include a AI/ML chat bot engine 118 to run the chat bot processing for user questions that are submitted. The server system 110 can maintain metadata or other information related to the information cards 172a-172c that are presented to users, so that the information context of a card is passed on to the chatbot and is preserved when answering a user question about an information card 172a-172c.

The user devices 102, 105 can be configured to interact with the server system 110 and to present the stream viewing user interfaces through an extension module 120 or add-on module that serves as a local software agent. The extension module 120 can integrate with a web browser, document editor, messaging application, or other application of the user device 102, 105. The extension module 120 can store user login information for the user 101 so that the extension module 120 receives stream content for the specific personalized stream of the user 101. The extension module 120 can send context data 170 to the server system 110, for example by periodically sending text from the user interface (e.g., from a web browser window) to the server system 110. The extension module 120 also informs the server system 110 about the status of the user device 102, 105, such as when a viewing pane for stream content is opened or closed. The extension module 120 handles local caching of information cards to be displayed, and also receives updated information cards 172a-172c and provides those in a ranked order for the user 101. The extension module 120 also handles feedback and interaction of the user 101, such as receiving ratings assigned to information cards 172a-172c and passing them on to the server system 110, and responding to interactions with buttons or links in the information cards 172a-172c that trigger the retrieval of additional content, invoke other applications, or initiate API calls.

In the example of FIG. 1A, only a single user 101 is shown, however the server system 110 is configured to support many users concurrently, with their own streams being personalized to their respective contexts. Similarly, a single administrator 103 is shown, but the server system 110 provides a platform in which many administrators, including from different companies or organizations, can separately define channels for their own sets of users.

Referring to FIG. 1B, an example of the processing performed by the server system 110 is illustrated in further detail. In this instance, the user 101 has connected to multiple different channels 180a-180n, where each channel 180a-180n has a connection to its own combination of data sources 140 or third-party systems and services 142, and each channel 180a-180n also has its own set of card definitions 151, corresponding triggers and conditions for those cards that are defined, and other settings as specified by the channel creator or administrator. The information stream for the user 101 is made-up of content from the combination of channels 180a-180n.

In the example of FIG. 1B, a first channel 180a has three cards defined (e.g., cards A, B, and C), a second channel 180b also has three cards defined (e.g., cards D, E, and F), and a third channel 180n has three cards defined (e.g., cards G, H, and I). The information stream for the user 101 is made as the combination of relevant cards from each of these channels 180a-180n. The server system 110 uses the context data 170 from the user device 102 to determine which of the cards from the various channels 180a-180n have been triggered for presentation. The server system 110 determines that the triggers or conditions 152 for three of the cards have been satisfied, for card A in the first channel 180a, and for cards D and E from the second channel 180b. The server system then determines a relevance score or priority score for each of the cards that have been triggered, and this place is card D with the priority score of 86, card a with a priority score of 72, and card E with a priority score of 68. The server system 110 ranks the card according to their priority scores and sends them over the network 108 to the user device 102 where they are displayed in a stream viewing pane 190. As a result, the user 101 sees the cards 172a-172c that the server system 110 identifies as most relevant to the current context of the user interface of the user device 102. The cards or other content items from different channels 180a-180n can be presented together and integrated into a single stream in the stream view interface 190.

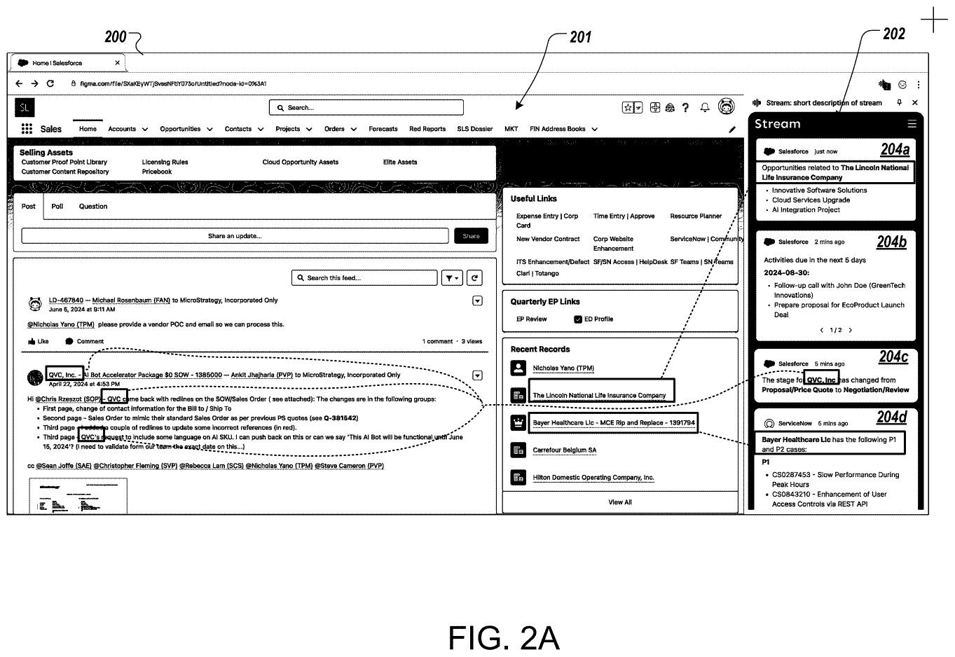

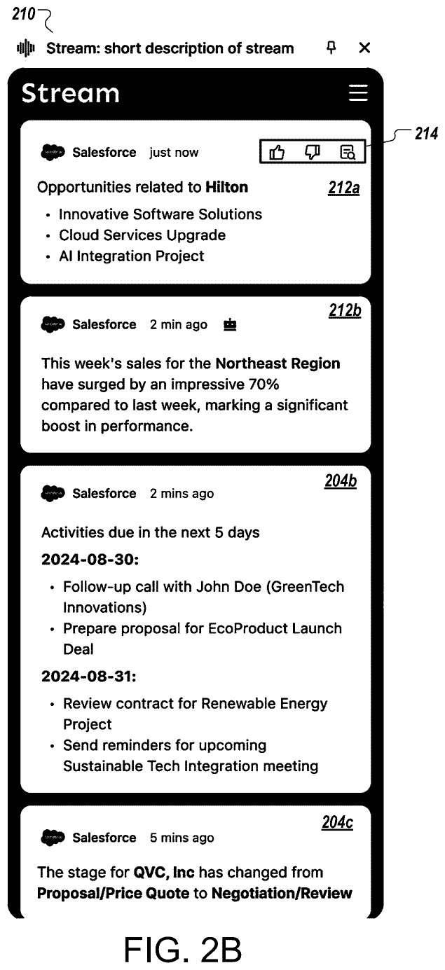

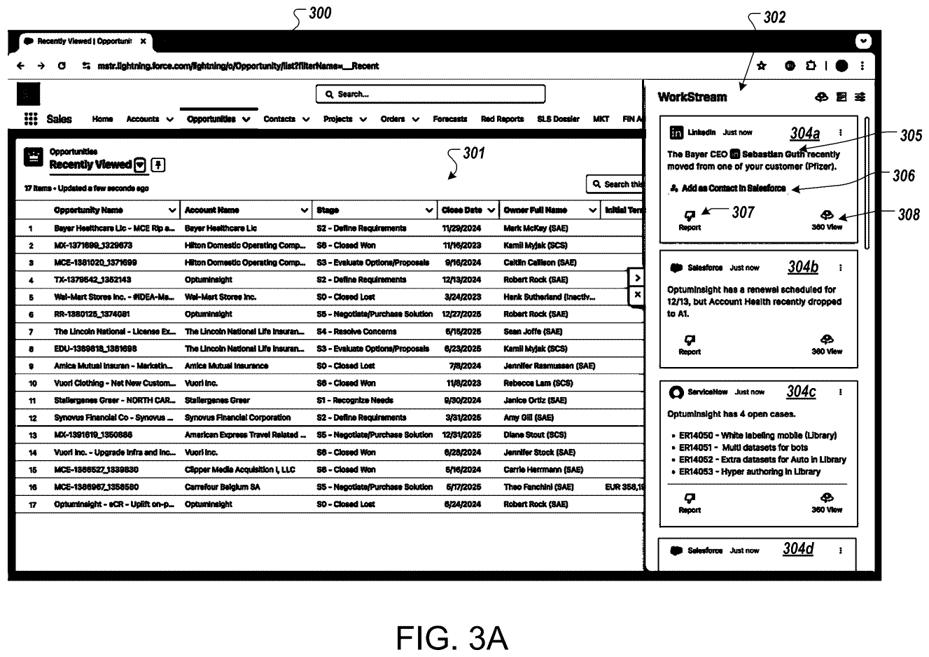

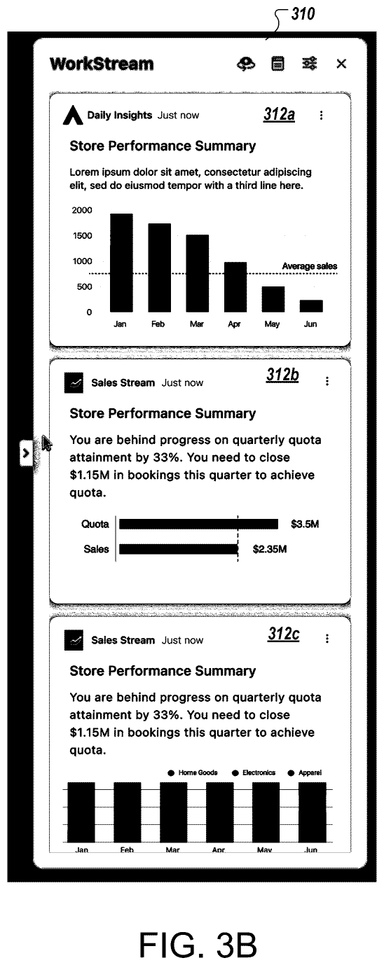

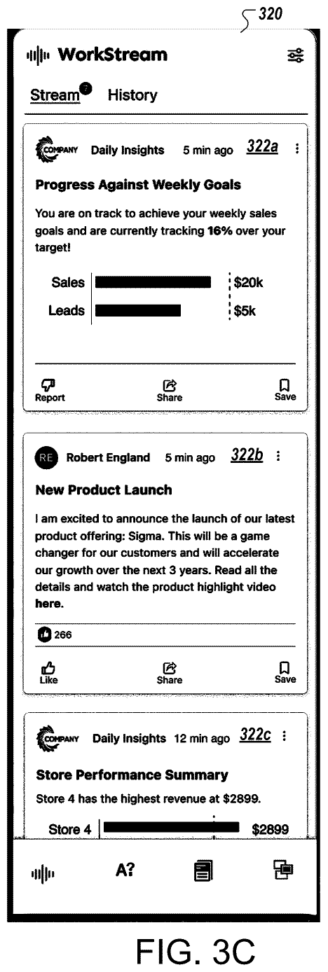

FIGS. 2A-2B and 3A-3C are diagrams that show examples of user interfaces providing information based on the context of the user.

FIG. 2A shows an example of a user interface 200 in which a user is viewing a web page 201 in a web browser and the information stream for the user is shown in a viewing pane 202, arranged as a sidebar. The server system 110 analyzed the content of the web page 201 from the user interface 200 and identified various entities that are referenced, including “The Lincoln National Life Insurance Company,” “QVC Inc,” and “Bayer Healthcare LLC.” In some implementations, the detection and extraction of entity names and other keywords is performed locally by the user device, and extracted keywords such as entity names are sent to the server system 110 instead of larger sections of text from the user interface 200.

The server system 110 has identified and generated a number of information cards 204a-204d that are relevant to the user. Some of the information cards are identified as relevant based on the web page 201, based on the context data indicating that specific entities are referenced. For example, the information card 204a provides information about sales opportunities for The Lincoln National Life Insurance Company, with links to information from a database or a third-party system (e.g., Salesforce) to view or act on those opportunities. The information card 204a represents one of many different information cards available that relate to The Lincoln National Life Insurance Company, but the particular card 204a shown is the one that is indicated to have the highest relevance to the user at the current time and based on the content of the current web page 201. In particular, the information card 204a is not simply a card describing the entity or representing a single predetermined set of information types that should always be displayed when the entity is mentioned. Instead, the information card 204A represents a particular condition, such that available sales opportunities for this particular entity exist, and the card 204A provides links or controls that allow the user to Select individual opportunities to view them and act on them in the corresponding third party system's portal.

The server system 110 can use a single card definition 151 to generate cards similar to the information card 204a for each of many entities for which sales opportunities exist in a database or account with a third party system. This results in many different information cards from a particular card definition or card template, each relating to the sales opportunities of a different entity. Then, the service system 110 assesses the relevance of all of the cards to the particular context of each user, to select out of the group of cards generated for the channel which cards (e.g., the cards of which entity or entities) are currently relevant to the user's context.

As another example, the information card 204c indicates that the stage of a process for the entity QVC Inc has changed from a “Proposal/Price Quote” status to a “Negotiation/Review” status. This information card 204c was generated based on a status change or event specified by a third party system or service 142 (e.g., Salesforce), and other information cards indicating similar types of change in status can be generated for other entities and other processes. In this case, the server system 110 determined that the status change indicated in the information card 204c is relevant to the user based on the content in the user interface. In particular, the web page 201 includes a discussion about the particular sales process that is ongoing with QVC Inc., and so the change in the status or stage of that process is particularly relevant.

As another example, the information card 204d provides information relating to Bayer Healthcare LLC, in particular, an indication of customer support tickets for software support. This information is derived from a different third party service or platform (e.g., ServiceNow) that is different from the one used to generate the other cards 204a and 204b, and may be provided by a different channel then those other cards. The information card 204d includes a list of customer support items, with each including a link to further information about the item, such as a link to portal or interface for the third party system to act on those items.

In each of the information cards 204a, 204c, 204d, a different type of information is provided. In many cases, it is beneficial for and information card type to provide a single category or type of information, and do so for a single entity. Instead of providing a predetermined set of information types for all entities of a given type (e.g., the same types of information for each company, or each customer, etc.), the server system 110 can be configured to evaluate and generate many different types of information cards for a given entity or entity type. This provides increased versatility for the server system 110 to identify specific information cards that are more targeted for individual users, compared to more general information about an entity. In other words, 4 two different users, or for the same user at different times or with different interface content shown, information cards with different types of information can be provided, because the relevance of those different types of information varies from one situation to the next.

In addition, the server system 110 considers a variety of factors in determining relevance and priority of information cards, beyond simply the presence of a keyword. For example, factors other than the presence of the keywords in a user interface can modulate the importance of particular types of information, and thus particular information cards. Factors such as the recency of a change in status, the magnitude in the change of a value, the deviation from a pattern in database records, the occurrence of an event indicated by a third party platform, and so on can trigger the generation of an information card for a particular type of information about an entity, as well as the relevance or priority of that information card relative to other information cards for the entity and for information cards for other entities.

Another example information card 204b shows activities that are due for the user in the next five days. This information card 204b shows an example of a card that is triggered and generated based on the current time, and the fact that there are items do within the window of the upcoming five days, instead of based on identifying keywords or entity names in the web page 201. In general, administrators can define the triggers and conditions 152 for generating information cards based on many different factors, including those that are not based on content of a user interface.

FIG. 2B shows another example of a viewing pane 210 for a stream. The viewing pane 210 can be presented as a sidebar next to a web page or application window, as a overlay over a web page or application window, or in another form.

The viewing pane 210 shows information cards 212a, 212b, 204b, and 204c. The set of information cards shown includes some cards 204b, 204c in common with the viewing pane 202 of FIG. 2A, and others that are different, as well as a different ordering or ranking of the cards. This difference can represent a change to the stream for the same user as FIG. 2A, but with the stream content being updated due to the passage of time (e.g., with new items with higher priority being presented), or due to a change in the context of the user (e.g., navigation to a different web page, change in the content of the web page 201, etc.), or a combination of factors. As another example, the viewing pane 210 can represent the stream of a different user than the one of FIG. 2A, where the user of FIG. 2B may be connected to one or more of the same channels as the user of FIG. 2A, but receives a different mix of information cards due to factors such as a different current context, a different interaction history, being subscribed to a different combination of channels, and so on.

In the example, the information card 212a shows the same type of information as the information card 204a, e.g., sales opportunities for an entity. However, the information card 212a shows that type of information for a different entity (e.g., Hilton rather than The Lincoln National Life Insurance Company) because the new entity Hilton is more relevant to the current context.

The information card 212b shows that sales in the Northeast Region have increased by 70% compared to the last week. The corresponding card definition 151 can be defined to indicate changes in sales by region, and the corresponding trigger or condition can be that the card is generated when the sales amount meets or exceeds a threshold, such as 50%. The sales increase of 70% satisfied the trigger and so the server system 110 generated the information card 212b for a particular channel that is part of the stream for the user of FIG. 2B. Then, the server system 110 calculated that the relevance of the information card 212b is sufficiently high (e.g., relative to other cards or to a minimum threshold) to cause the information card 212b to be presented to the user.

In some implementations the information cards in a user's information stream are provided as a feed in which new items are populated sequentially. For example, a new information card can be inserted at the top of the viewing pane 210 and other existing information cards can be pushed down as a result. For example, the information card 212a may be most recently presented, the information cards 212b and 204b were presented 2 minutes ago, the information card 204c was introduced 5 minutes ago, and so on. Information cards may be removed or reinserted into the stream in some cases as the context of the user changes and thus the relevance of those cards to the user changes.

FIG. 3A is another diagram that shows an example user interface 300 providing information based on the context of the user. The user interface 300 shows a web page 301 that has a list of information about corporate opportunities. It includes information about a name for the opportunity, an account name or company corresponding to the opportunity, a stage or status of the opportunity, a closing date, and an owner name. At the point shown in FIG. 3A, the user has Interacted with an icon or other control to cause a stream viewer pane 302 to be displayed. In this case, the stream viewer pane 302 extended to the left, from the right hand side of the user interface 300, as an overlay on top of the web page content. The stream viewer pane 302 shows a variety of information cards 304a-304d. These information cards are taken from one or more of the channels that the user is subscribed to or connected to to form the user's stream. From the information cards that are triggered or available from each channel, the server system 110 has ranked the priority or relevance to the particular user, and has identified these information cards as the most relevant and currently applicable to the user and his context.

The information card 304a includes information from third-party service LinkedIn. The information card 304a includes information about a contact or person associated with the user's customer, Pfizer. In particular, it indicates that the CEO of Bayer recently moved from the user's customer, Pfizer. The information card 304a can be generated based on one or more different types of card definitions 151. In some cases, the card can be created dynamically based on analysis of data, rather than a predefined card definition. As an example, a card definition 151 can be defined that relates to job changes, so that information from LinkedIn or other sources that indicates a person changing jobs or changing titles triggers the generation of a card, and then cards related to people or companies that are relevant to the user are shown to the user. In this scenario, a card definition can be defined specifically to notify users of job changes or title changes.

As another example, the server system 110 or a channel may be more generally configured to monitor changes in data and describe the changes in data in an information card, perhaps without formally defining job changes or title changes as a specific type of card or trigger for a card. Instead, the server system 110 can detect changes in status or changes in values of various fields, and then can use one of the AI/ML models 132 to generate a description of the change. The server system 110 and/or the AI/ML models 132 can then assess the relevance of the change to each particular user to determine whether the card should be shown to that user.

The information card 304a also includes a number of links or interactive controls that can provide the user quick access to other interfaces or systems. For example, the link 305 on the CEO's name allows the user to click to open a view of the profile of the CEO in LinkedIn. In addition, the information card 304a includes a control 306 that the user can select to add the CEO as a contact in Salesforce. In this manner, the server system 110 and the information cards in the stream not only provide access to third-party services and systems, but a single information card can include information and provide access across different platforms. For example, in this case, the card 304a was triggered based on information from one third-party service (e.g., LinkedIn), and includes a control 305 to access the LinkedIn system and its data, and the information card 304a also includes a control 306 to perform an action in another system, Salesforce.

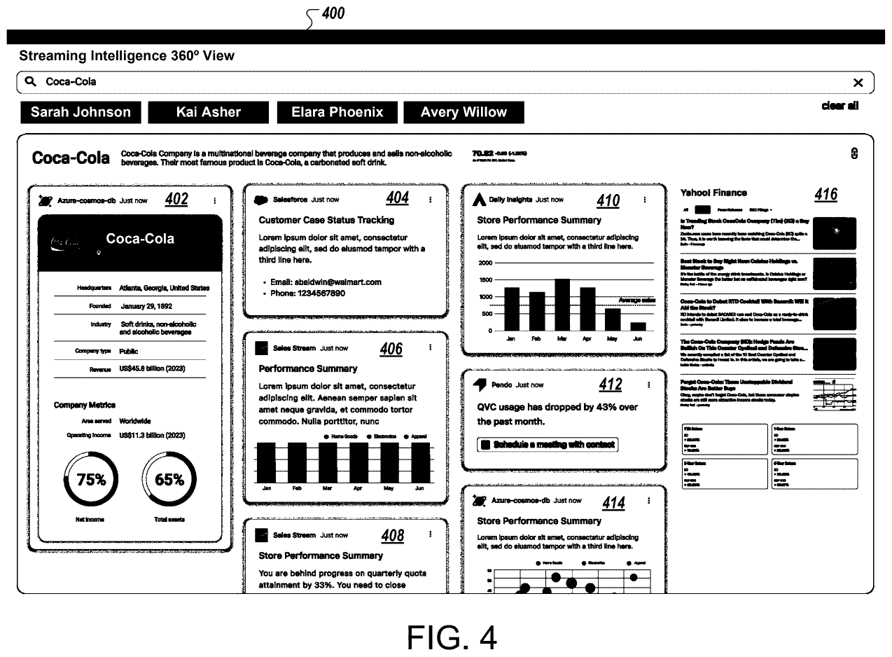

The information cards 304a-304d include other controls that can be used to access and manage the stream for the user. For example a control 307, shown as a thumbs down icon, allows the user to provide feedback about the quality of the information card 304a. In particular, the user can interact with the control 307 to indicate disapproval, a poor match, or poor quality content. Feedback from the user is collected and processed by the server system 110 to improve recommendations for this particular user and for channels as a whole, so that the quality for many users can be improved. The control 308 can be clicked to open a “360° view,” which is a type of interface that provides a focus on a particular entity or subject. For example, by clicking on the control 308, the user can initiate access to a new web page or view that shows much more information about the topic of the information card 304a, which is the CEO Sebastian Guth. An example of a 360° view interface for a different topic (e.g., the Coca-Cola Company) is shown in FIG. 4.

The information card 304a provides information from the Salesforce third-party platform, which indicates that a renewal is scheduled for customer OptumInsight at an upcoming date (e.g., December 13), and indicates that account recently dropped to a status of A1. The information card 304b is presented based on the server system 110 determining that the company is relevant to the current web page 301 based on the name OptumInsight being included in the web page 301, e.g., in the account name column. Note that the type of content in the information card 304b is not simply a predetermined card or a predetermine type of content configured to be shown each time a company's name or even the specific OptumInsight name is detected. Rather, the content of the information card 304b is determined based on the upcoming renewal date and the change to the status of the account for the OptumInsight entity (e.g., account health level has recently dropped). The content of the information card, and whether to present the information card at all, is based on the change of status in a record, which in this case is a record of a third-party service or system. This example also shows how timing is used in selecting information cards and relevance also, with the card being surfaced due to the upcoming renewal date and the recent status change.

The information card 304c includes information about OptumInsight, one of the companies listed in the account name column. The information is taken from the service now third party service and it includes a list of the open cases or service tickets for the company OptumInsight as a customer in the ServiceNow platform. The service ticket identifiers are hyperlinks that the user can select to open up the corresponding information, such as in the service now web portal.

FIG. 3B shows another example of a stream viewer pane 310. The stream viewer pane 310 shows information cards 312a-312c that each include different visualizations of data.

For example, the information card 312a shows a store performance summary along with a bar chart with monthly sales numbers for a store. The information is taken from a “Daily Insights” service or data set. The information card 312a could be triggered for generation in a channel, and thus in the user's stream, in any of various ways. For example, the card may be configured to provide the performance summary periodically, e.g., daily, weekly, monthly, etc. As another example, the information card can be set to provide the summary when the trend matches a particular pattern or the values have certain characteristics. For example, the card can be triggered for any of various stores when the recent month's performance falls below the average for a window, or falls below the average for two consecutive months, or falls below the average by at least a threshold amount or percentage, etc. As discussed above, the conditions to trigger generation of a card in a channel can be set by an administrator or can be learned by the server system 110 using the AI/ML models 132 to evaluate data sets, trends, and user behavior. The selection of which information card(s) from a channel to show to a particular user at a particular time can be determined based on relevance of the content (e.g., store, location, people mentioned, etc.) to the context of the user (e.g., user's current user interface text, the user's upcoming calendar appointments, the user's current location, the user's recent messages, and so on).

The information card 312b shows a different type of store performance summary, based on a different data source, e.g., “Sales Stream.” This information card 312b provides information about sales status compared to a quota, and shows a chart of the current sales amount compared to the quota. As with other cards, the condition to trigger generation and/or presentation of the card can be based on a predetermined condition, or potentially one of multiple conditions. For example, the card can be generated periodically, such as weekly or monthly, to show progress toward the quarterly quota, regardless of whether the current value is ahead or behind the target. As another example, the card can be generated and presented in response to determining that the value or trend is behind a target value or trend, or is below the quota by some amount or percentage.

The information card 312c is another example of a store performance summary, showing a different graph that shows a breakdown of sales by product category, among home goods, electronics, and apparel. The information card 312c can be provided when, for example, the product category information is determined to be relevant to the user's context, such as when the user sent or received messages about the categories listed, or is viewing a page about one or more of the product categories, and so on.

FIG. 3C is another example stream viewer pane 320 that shows information cards 322a-322c for a user. One information card 322a shows progress with respect to a user's weekly sales goals. Another information card 322b shows an email that the server system 110 surfaces in the stream because it is determined relevant or important for the user in the current context. The third information card 322c shows a store performance summary indicating the store with the highest performance.

FIG. 4 is a diagram that shows an example of a user interface 400 that shows information provided about a particular entity. The user interface 400 can be shown when, for example, a user receives an information card in the stream and selects to view more detailed information about the subject of the information card, such as by clicking a button or other control such as the control 308 shown in FIG. 3A.

The user interface 400 includes a general information card 402 that provides information about a particular entity, in this case, the Coca-Cola company. The information card 402 provides an address, website, headquarters, date founded, industry, company type, yearly revenue, and provides other company metrics. The general information card 402 can be a type of information card that provides the same or similar type of information for all entities of a same type, such as companies.

Other information cards 404, 406, 408, 410, 412, and 414 show information about the main topic, the Coca-Cola company, taken from various data sources 140 and third-party services or systems 142. The various information cards can be taken from any of various channels that the user is subscribed or connected to. This allows information relating to the main topic, the Coca-Cola company, to be collected in one user interface 400, so that information about the company overall, about sales of the company's products in different stores, status of the company as a customer, and other aspects to be reviewed together. The information card 416 also shows new about the Coca-Cola company and its products.

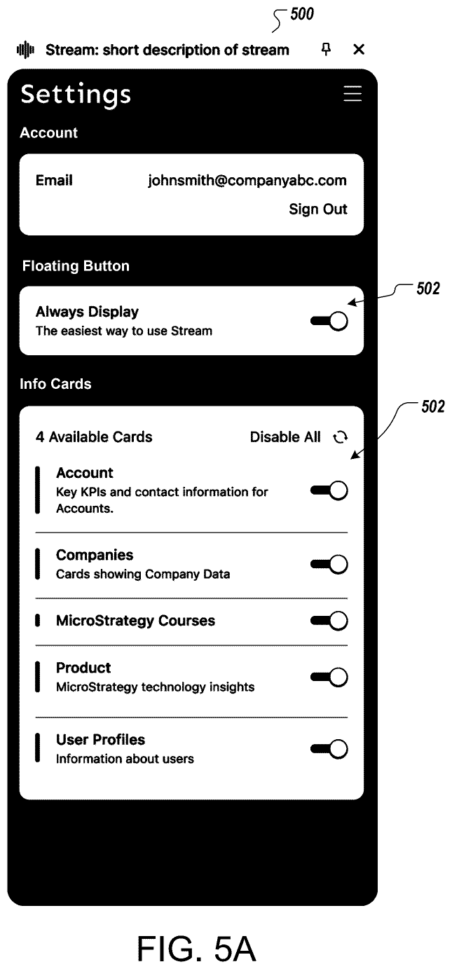

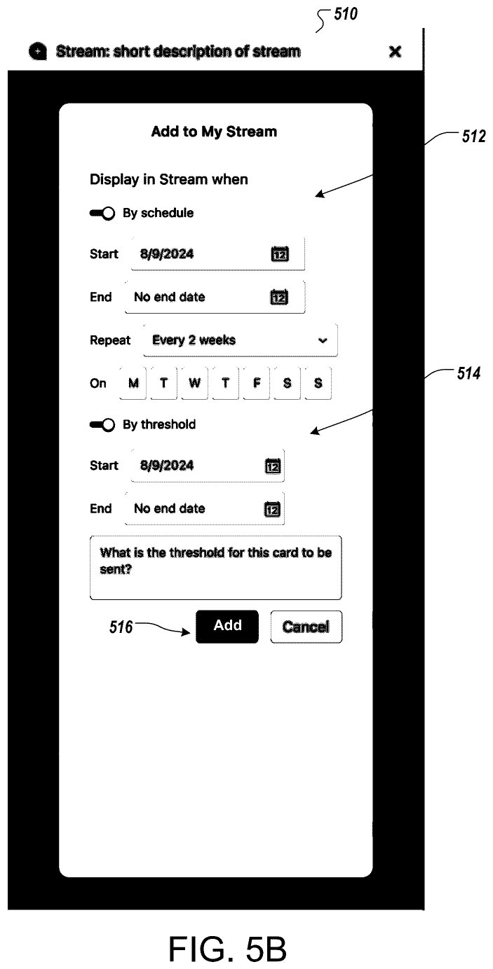

FIGS. 5A-5B are diagrams that show examples of user interfaces for changing settings for providing information to a user. In FIG. 5A, the user interface 500 shows how a user can log in with an email address or username, and has a control 502 to set the stream viewer pane to be always shown or to be selectively shown or hidden. Another area 504 lists a set of information card types that are available for the user, along with controls to enable or disable those types of cards in the user's stream. This gives the user control to adjust which types of information cards will be shown.

FIG. 5B is another user interface 510 that provides controls for setting the conditions or timing of display of a particular type of information card. For example, the controls enable a user to set a card to be displayed in the stream by a schedule and/or by a threshold. The schedule controls 512 allow the user to set a start and end date, a repetition setting (e.g., every two weeks, or another selected interval), and to specify which days of the week to provide the information card.

The threshold controls 514 provide functionality to set a threshold for triggering creation and/or display of the information card. Besides setting a start and end date for the information card to apply, the user can specify in natural language the condition that should apply. The user can then enter a description of the threshold that should apply, such as “show when sales exceed 2000 units,” or “monthly sales differ from previous month by at least 20%,” or “when the status of employee John Doe changes.” The server system 110 receives the natural language statement and the processes it with the AI/ML models 132 to generate a statement that the server system 110 can apply.

The processing of user-entered threshold statements can include mapping terms in the user-entered natural language text to data types and data sources, as well as identifying operators and expressions (e.g., equals, less than, greater than, etc.) that operate on the values from data sources to apply the threshold. In some cases, the AI/ML models 132 are provided a data model that lists the logical objects (e.g., metrics, attributes, etc.) that are available, as well as descriptive data (e.g., names, descriptions, metadata, sample values, and so on) for each logical object. The AI/ML models 132 can use the semantic meanings of the user-entered terms to select the best-matching logical objects, which may represent database columns, aggregation results, or other data, including potentially values obtained from third-party services or systems through an API. The AI/ML models 132 can be asked to provide an output in a form that the server system 110 can apply efficiently, such as an SQL statement, Python code, a mathematical expression, a Boolean expression, etc.

For example, consider the case where the user enters the phrase “show when sales exceed 2000 units” as the threshold statement for showing an information card from a particular channel. The server system 110 provides to the AI/ML models 132 the user's statement along with the data model for the data sets and third-party services for the channel that the information card is generated from. From the various logical objects, such as “company name,” “gross profit,” “number of employees,” “revenue,” “unit sales,” etc., the AI/ML models 132 select the closest match, e.g., the “unit sales” column. If the user had specified a filter, such as a time range or geographical restriction, then the AI/ML models 132 would map those to an aggregation or filter setting to apply. In this case, the AI/ML models 132 may infer that the sales should be for the current year, and can generate an expression that aggregates unit sales for the current year and compares the number to the 2000 unit threshold. In some cases, the server system 110 can provide the expression and/or a description of the expression to the user to verify that it was translated correctly into an expression for the server system 110 to apply. Then, the interface enables the user to edit the expression, change the time range (e.g., from yearly to quarterly), or make other changes.

Once the user is satisfied with the trigger schedule and/or threshold trigger conditions, the user can select a control 516 to add the card or the new triggering properties to the stream. In some cases, the same type of user interface 510 can be provided for users to edit the triggering conditions of other cards already in the channels for the user.

In general, the administrators control the channels of information cards, by specifying data sources, types of information to show (e.g., types of information cards), and the default triggering conditions. Then, individual users can further customize the behavior of their own personal stream by selectively enabling or disabling particular cards from any of their subscribed channels, and by adjusting the triggering conditions to supplement or override the settings used generally by the channel.

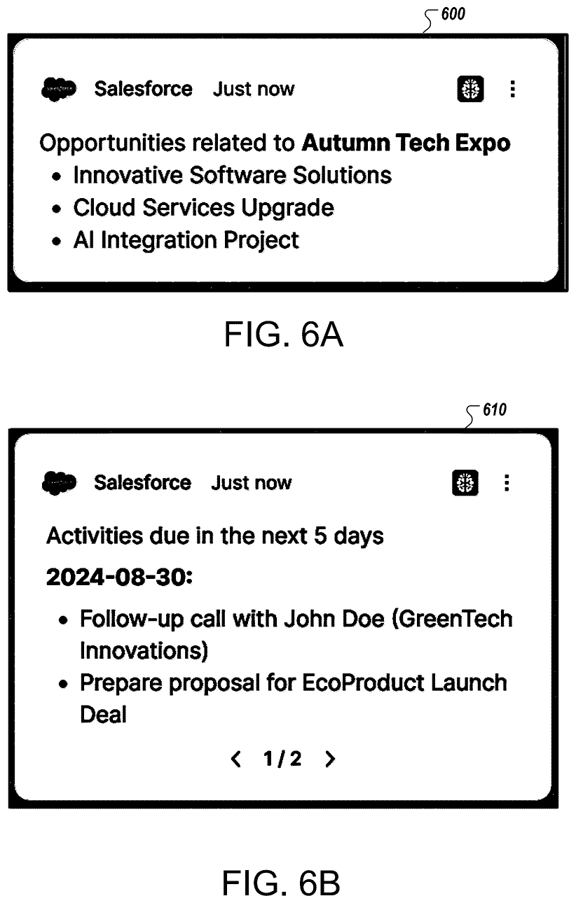

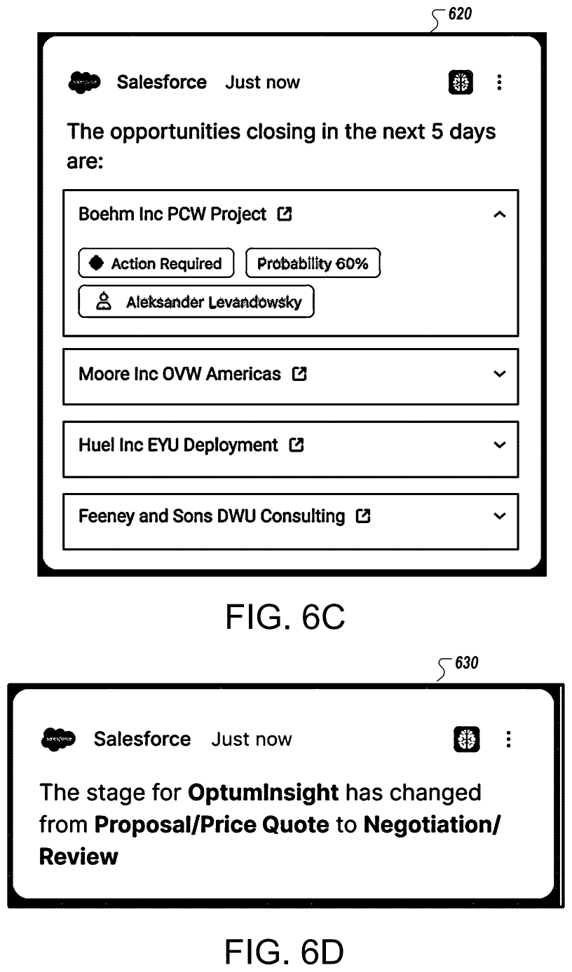

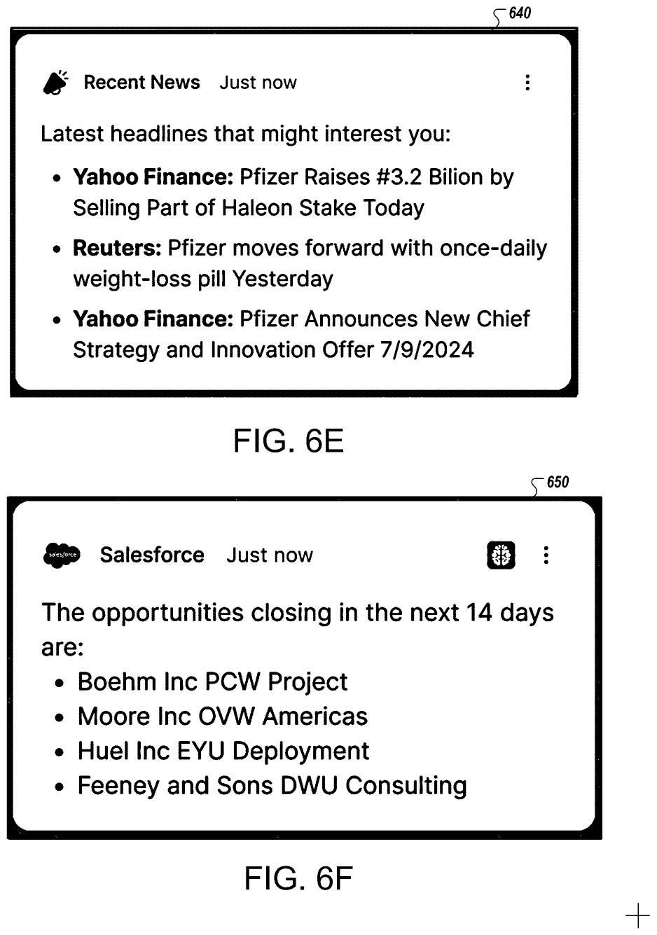

FIGS. 6A-6F are diagrams that show examples of information cards. FIG. 6A shows an information card 600 with a list of opportunities, with each element in the list being interactive to bring an interface for viewing further information or taking action on the item. In FIG. 6B, an information card 610 shows a list of activities due in the next five days, with each item in the list being made interactive to respond to a user selection by bringing up an interface for reviewing or acting on the item. FIG. 6C shows an information card 620 that lists opportunities closing in the next five days. Each of the four items can be expanded or closed, and when expanded they show status (e.g., “action required”), a likelihood of success (e.g., “Probability 60%”), and a name of a contact person (e.g., “Aleksander Levandowsky”). An item in each item can also be interacted with to open the opportunity in a portal for a third-party service, such as Salesforce. FIG. 6D shows another example information card 630 showing that the stage of a project or opportunity for a company, e.g., OptumInsight, has changed from a proposal/price quote stage to a negotiation/review stage. FIG. 6E shows an example of an information card 640 showing new headlines, with hyperlinks to web pages with more information about news stories selected as relevant to the user (e.g., related to the company Pfizer, which was determined to be of interest to the user). FIG. 6F shows another example information card 650, showing a list of opportunities closing in the next 14 days, with the names of the projects which also serve as hyperlinks or controls to access information about those projects.

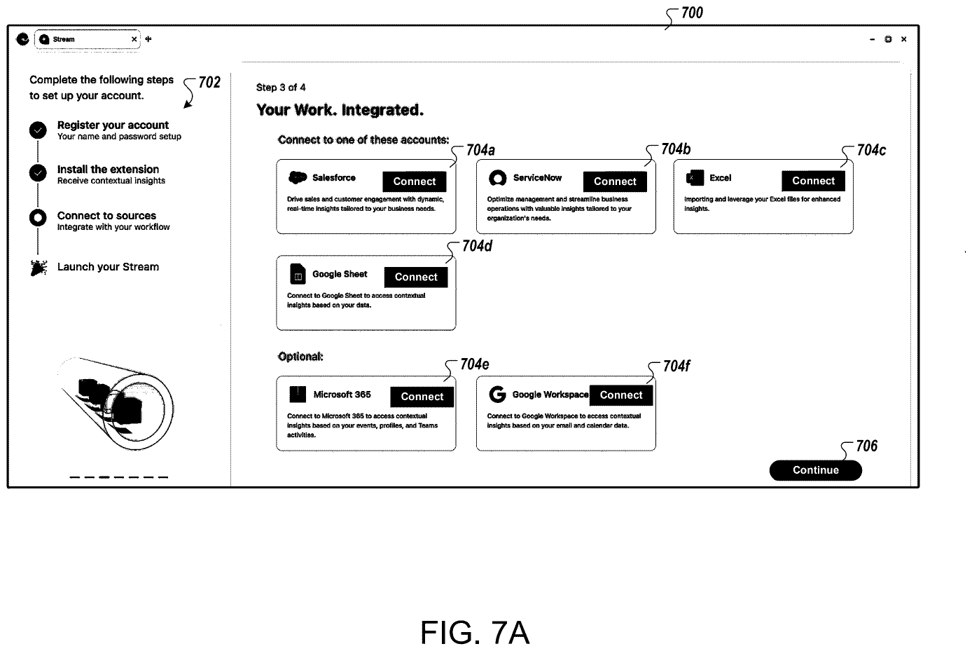

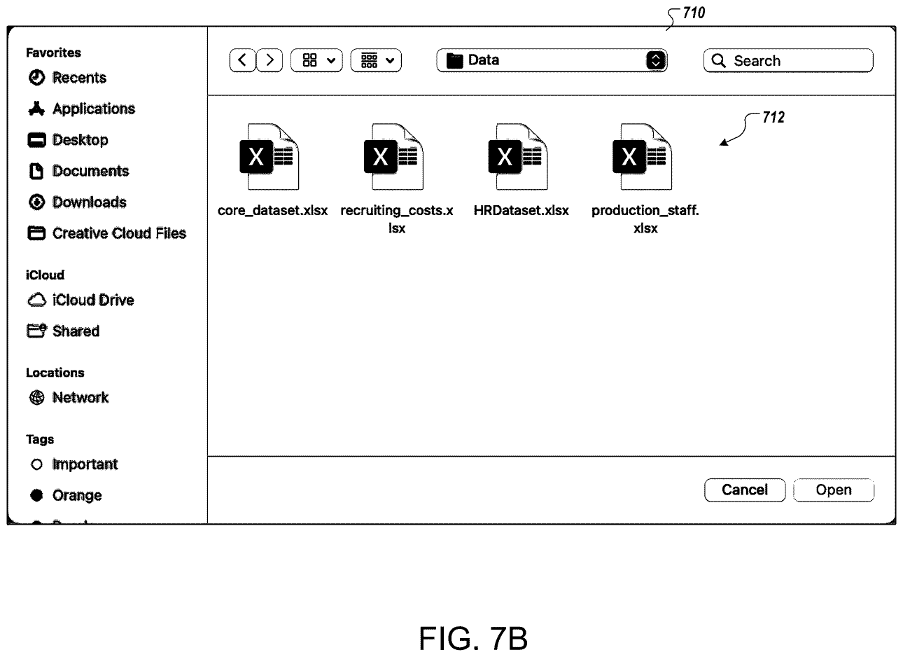

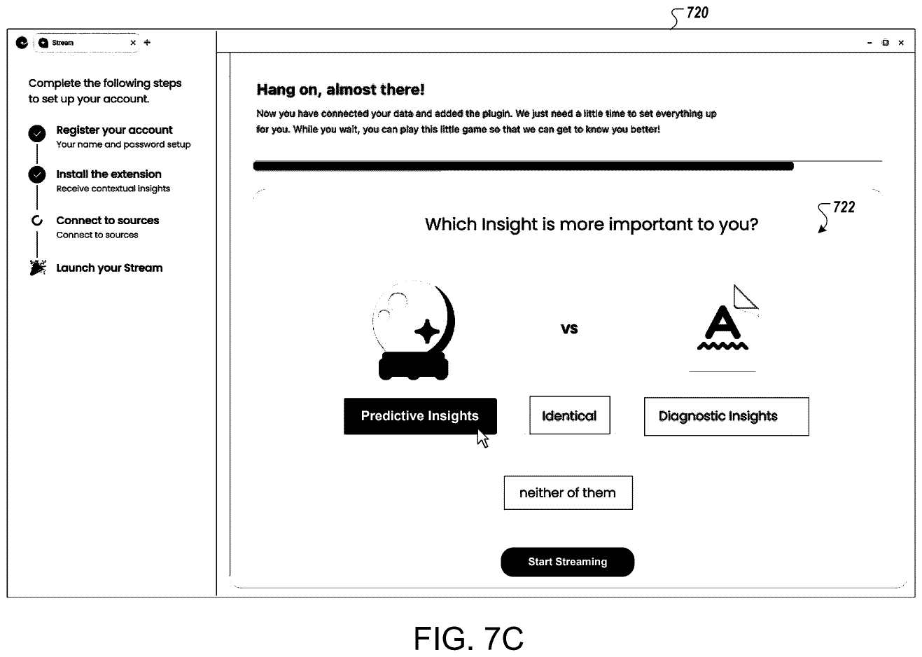

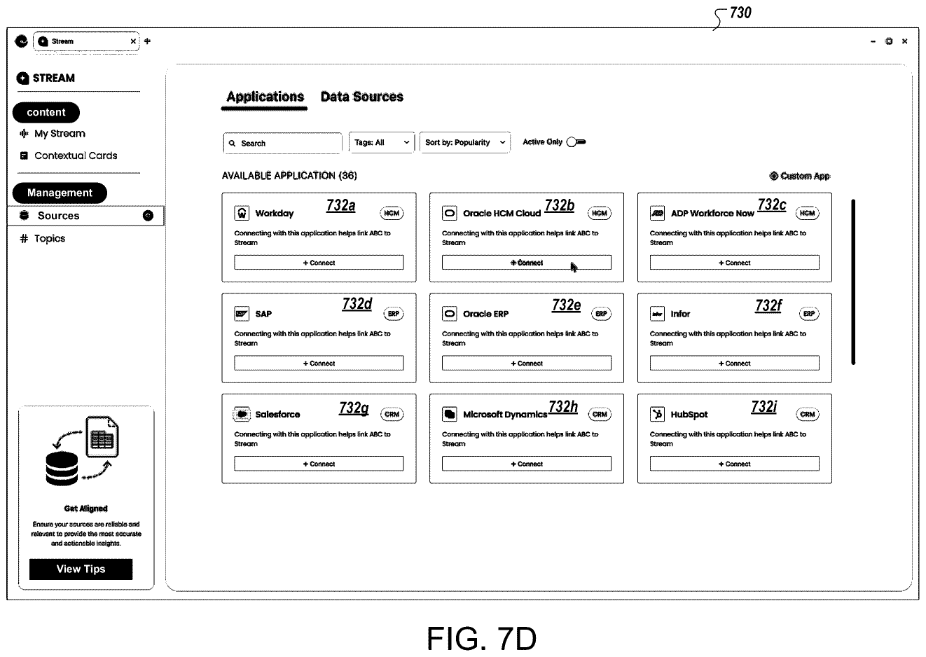

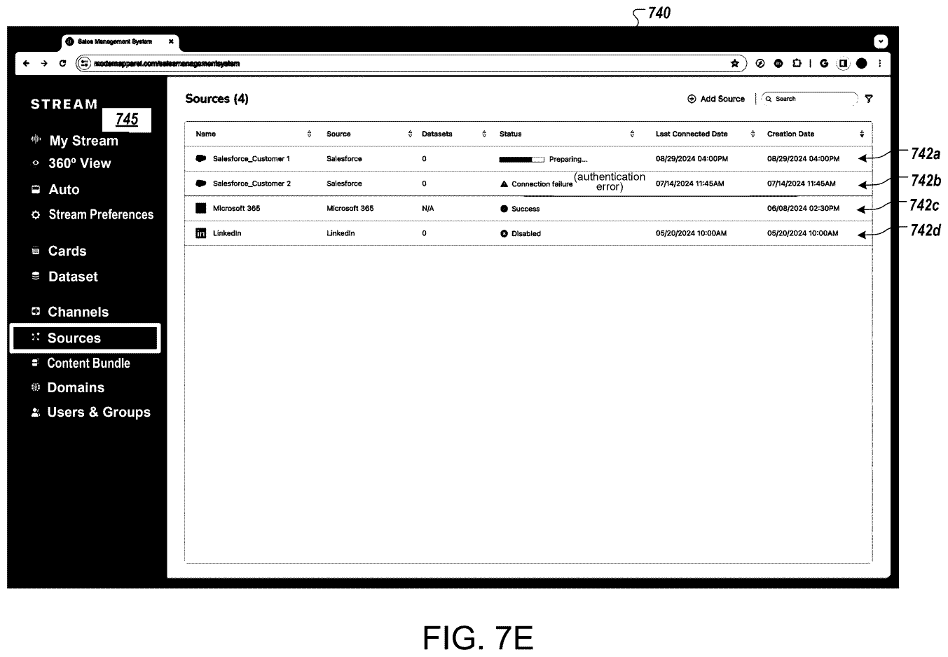

FIGS. 7A-7E are diagrams that show examples of user interfaces for configuring data sources to provide data from various sources through customized information channels.

FIG. 7A shows an example of a user interface 700 that the administrator 103 can use to set up an account and begin customizing information channels for user streams. The user interface 700 is an example of a web page, web application, or other interface that the server system 110 can provide for display at the administrators device 104.

The user interface includes a guide region 702 that indicates the current status among a series of steps for adding a new account and launching channels for user streams. The guide region 702 indicates that the first step is to register an account by specifying a name, password, and other information. Next, the administrator 103 installs the extension module 130 on the administrator device 104 to access the information about the streams. Many management features can be done through a web-based interface in addition to or instead of through a local application. The next step is for the administrator 103 to connect to data sources, so that timely, contextually-driven information from enterprise data sources can be surfaced to users. The streams shown to users are intended to integrate with the data sources that users interact with on a day-to-day basis. The streams of information that users receive can thus reflect the information about the tasks, customers, systems, products, and relationships that users already have. In the example, the administrator 103 is required to select at least one data source in order to proceed and launch a channel or invite users to receive stream content.

The user interface includes a variety of data source elements 704a-704f, each of which provides an option to connect to a different data source 140 or third party service or system 142. For example, the element 704a represents the Salesforce application, and allows the administrator 103 to initiate a sign-in process with that third-party service, and so link the Salesforce data and events to the information stream system. Once the administrator 103 initiates the connection, enters a username and password or other authentication information, and the server system 110 completes the integration, the data sources, databases, and other information from the Salesforce platform will be available for the server system 110 to draw from, both in generating content of information cards as well as detecting conditions that trigger presentation of information cards. The server system 110 can include information about the API used by the Salesforce system so that the server system 110 can periodically retrieve data from the administrator 103 account in that platform. In addition, the server system 110 can be configured to receive notifications of events or changes in the company's data in the Salesforce platform, which can be very helpful to trigger the presentation of information cards.

The other elements 704a-704f provide entry points to initiate connections to other data sources and services or systems, such as ServiceNow, Excel spreadsheets, Google Sheets, Microsoft 365, Google Workspace, and others. The server system 110 can provide the administrator 103 the ability to connect to third-party servers, to database systems, to on-premises servers, to cloud computing platforms, to files stored locally or in network-attached storage, and to access data in various other ways. Importantly, the server system 110 makes connections that are ongoing and will refresh or detect changes in data from the data sources and detect events that occur in other platforms. As a result, the server system 110 will be able to repeatedly obtain and surface updated information for users through the streams.

After the administrator 103 has connected one or more data sources, the user interface 700 will enable the control 706, which the administrator 103 can interact with to continue setting up the account.

FIG. 7B shows another example user interface 710 in which the administrator 103 can open a document, such as a spreadsheet file, to import the document into the system and begin generating information cards and channels based on it. The user interface 710 shows a variety of documents 712 that have an appropriate data type to be imported into the system.

FIG. 7C shows another user interface 720 that shows interactive elements 722 that prompt user input during connection to data sources or importing of data. After the administrator 103 has specified the data sources and services to connect to, while the process is ongoing, the server system 110 can ask questions to begin customizing the types of information that will be provided based on those data sources. For example, the interface 720 can request that the administrator make a selection among different options, to bias or weight the types of information presented to users. In this case, the elements 722 request the administrator 103 to indicate a preference between predictive insights and diagnostic insights, or to indicate that both are important or that neither are important. The server system 110 can provide a variety of questions like these, discussing different categories of information or information cards, to begin setting the preferences for the information that will be displayed to users.

FIG. 7D shows an additional example of a user interface 730 for managing data sources. Even after the initial setup of an account or channel, the interface for the administrator 103 provides tools to update and change the set of data sources used. As noted above, the sources can be applications including various third party services or systems, including cloud computing systems and remote third party servers. Other data sources that can be used include databases, data cubes, spreadsheets, data warehouses, and so on. In the example, a variety of applications 732a-732i are listed, along with controls to initiate connections to each of these applications. The server system 110 can store a predetermined set of integration data for connecting to each application or data source. For example, the server system 110 can store profile data for each application, where the profile data includes a description of the API, a software development kit, authentication parameters, a description or list of the types of information available, information about the tasks or actions that can be performed, a list of URLs or domains for accessing different features of the application, and so on.

FIG. 7E shows an example of another user interface 740 that shows the status of data sources and their connection to the administrator's account. In this example, the administrator 103 has selected three different data sources, each of which are third-party applications, services, or platforms. There are two different Salesforce accounts, a Microsoft 365 account, and a LinkedIn account. The user interface shows a status of each connection. The first account is in the process of importing, and so has a status of “preparing” listed with a progress bar shown. The second source experienced a connection failure due to an authentication error, and so this failure is indicated so the administrator 103 can correct the error. The third source was successfully added, and this is specified for the user. The last data source has been disabled by the administrator 103, and so it is available to use but is currently not used by the server system for the administrators account.

The interface 740 can provide other information, such as the date and time the data source connection was first created, the last date and time that the source was connected to, and the number of data sets available from or used by the stream system for each source.

The user interface 740 also includes a navigation pane 745 that provides the administrator 103 access to many different types of settings. The top group of settings includes settings for the administrator's stream, with controls to view the stream, to view a “360° View” that provides more detailed information about particular entity or topic, to interact with a chatbot, or to access stream preferences. Other areas that the Navigation Pane 745 provides access to include information about information cards, data sets, channels, data sources, content bundles, domains, and users and groups of users. As discussed further below the administrator 103 can portions of the interface to set different types of settings or behavior for the channels of information that are provided to users.

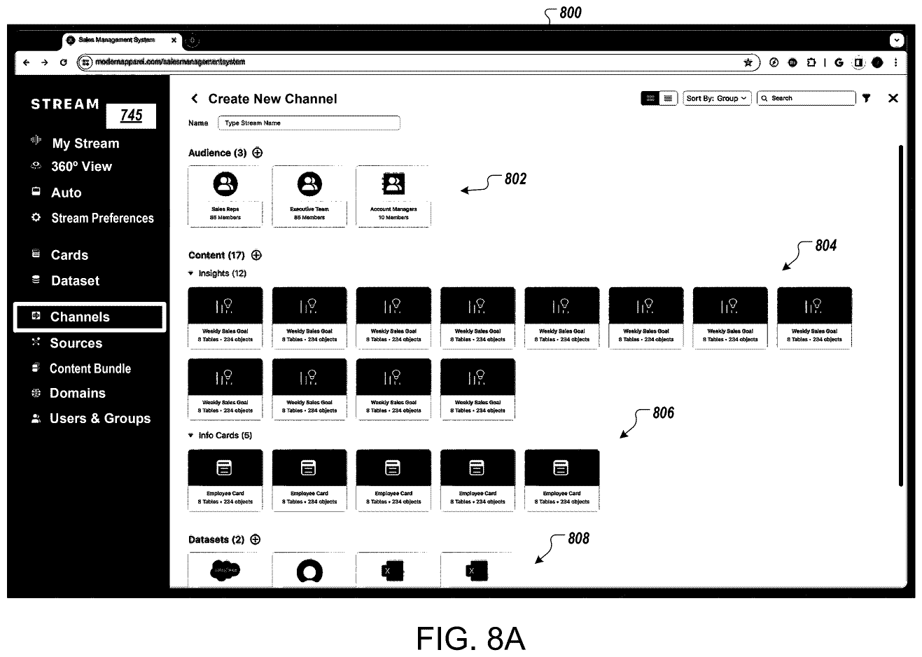

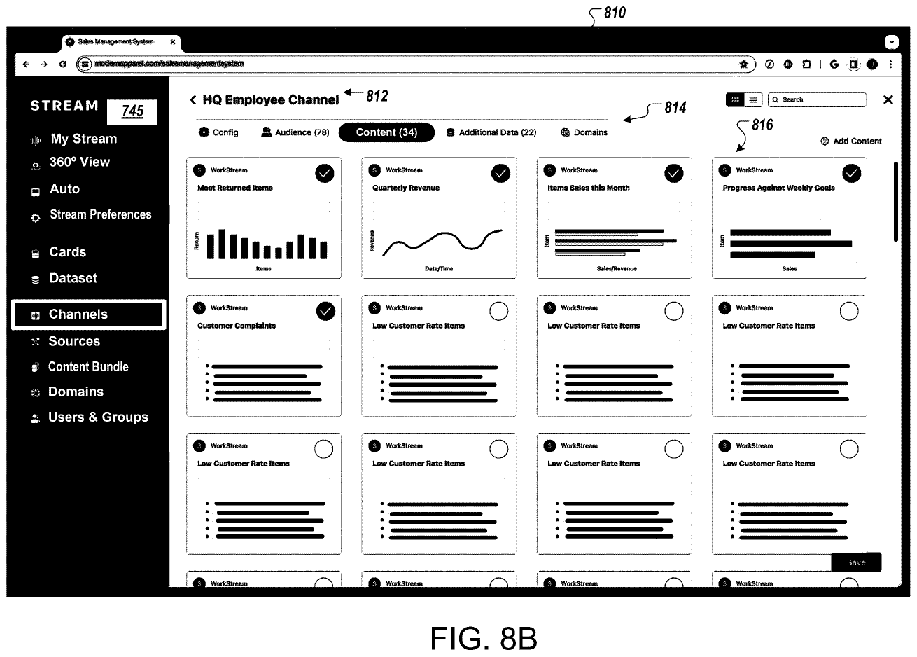

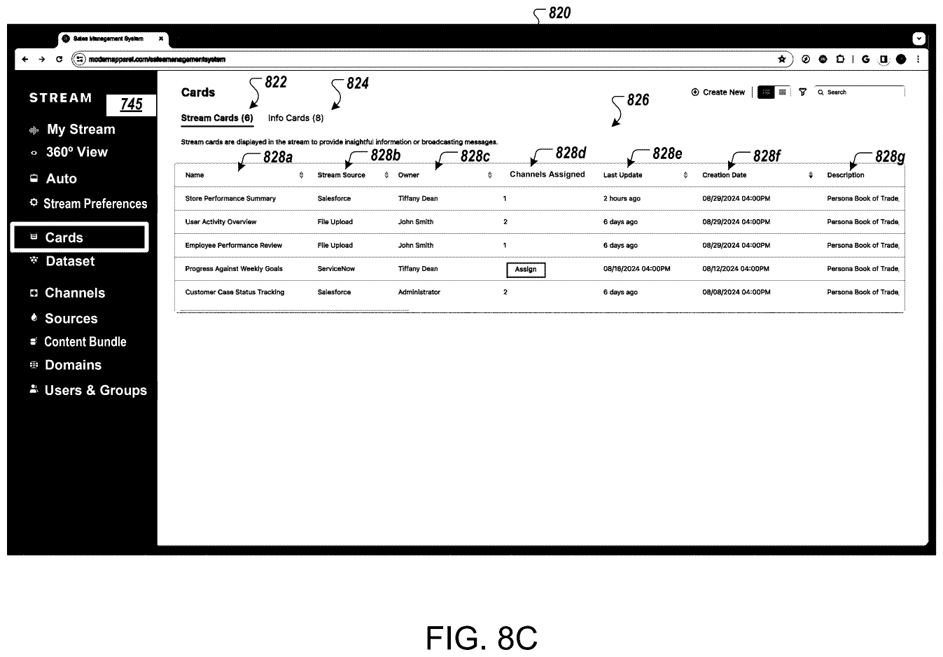

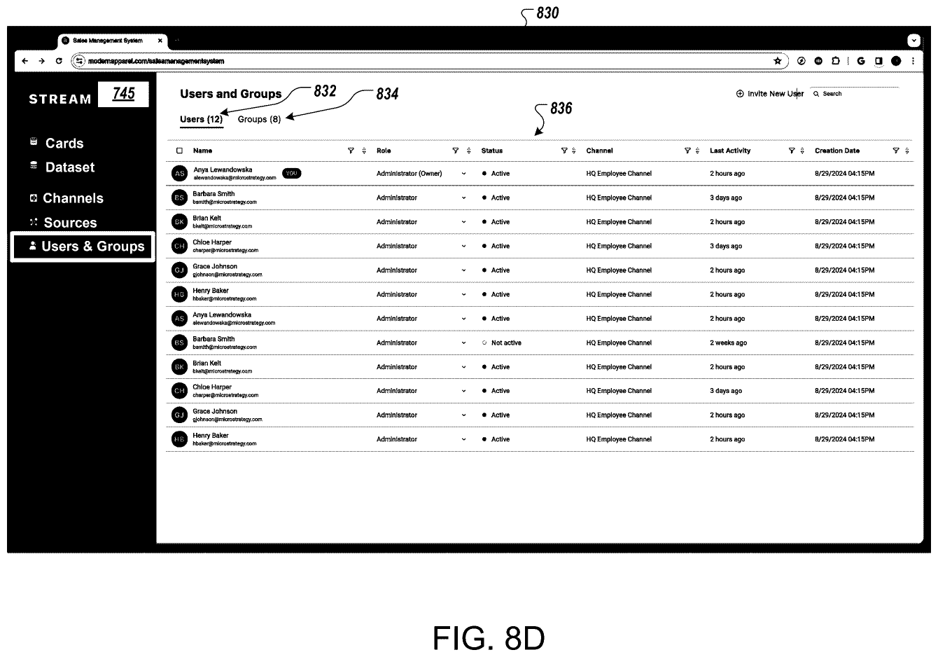

FIG. 8A shows an example user interface 800 in which the administrator 103 has selected the channels portion of the Navigation Pane 745. The user interface 800 provides features to create a new channel from the information and existing digital assets in the administrator's account. The illustrated example shows a number of selections that the administrator has made during the process of creating a new channel. Once a channel is created, the server system 110 begins detecting triggers of information cards and providing those information cards from the channel to the streams of the users in the defined audience for the channel. Each user will have their personal stream updated based on the cards from the various channels that the user is connected to or subscribed to.

The user interface 800 includes a set of user groups 802 that have been selected to receive information from the channel that is being created. In this case, three groups are listed, e.g., a sales representatives group, an executive team group, and an account managers group. The user interface 800 allows the administrator 103 to add additional users or user groups by selecting the “+” icon. In general, individual users or groups of users can be added or removed by the administrator 103 during creation of a channel or afterward.

The user interface 800 also includes regions for defining the content to be provided through the channel. For example, there are two broad categories of information cards, insight information cards and entity-based information cards.

A first region 804 shows insight information cards (e.g., “insight cards”), which each represent a template or card type that can be populated to create insight cards with values from a data source or application. The insight cards are typically focused on a particular type of information or event, and the insight cards are each associated with a corresponding trigger condition. For example, some insight cards may each be designed to provide information about a specific type of due date, a specific type of metric (e.g., revenue, profit, units sold, etc.), a specific type of status, and so on. Instance of the insight cards can be generated and/or shown to users when the server system 110 detects that the trigger condition for the insight card is satisfied. For example, the triggers can be based on timing, such as a daily, weekly, or monthly presentation. The triggers can also be based on the values or status of data in a system, to trigger an insight card when a status changes, a value changes, a value reaches a threshold, a value is inside or outside a range, and so on.

Instances of each of the insight cards can be generated across many different entities, topics, or situations, depending on the values from the data sources. For example, an insight card template can be designed to describe the current value or trend for units sold to a customer, or to notify of the units sold reaching a threshold. Based on the template, separate insight cards can be generated for each of multiple customers, e.g., units sold to Customer 1, units sold to Customer 2, units sold to Customer 3, etc. Although many of these insight card instances may be triggered for presentation and may exist in a channel, the server system 110 may selectively present the insight card instances based on the context of each specific user. For one user that is subscribed to the channel, the server system 110 may present the card for unit sales to Customer 1 when the user is viewing a message, calendar item, or web page that mentions Customer 1, and the other unit sales cards may not be presented (e.g., may not have sufficient relevance or priority to the user's context to reach the limited presentation window for the user). For a different user that is subscribed to the same channel, the server system 110 may present the card for unit sales to Customer 2 based on that user's context, and the card for unit sales to Customer 1 may not be presented if it is not sufficiently relevant.

In many cases, insight card instances can be triggered and presented without an entity or subject specifically being named in text of a user interface. For example, the trigger for an insight card may be that a metric reaches a particular threshold, or has not reached a threshold by a particular time. As a result, the server system 110 can detect that the condition has occurred based on the information from the connected data sources, and the server system 110 can generate and send the insight card instance without needing the company, account, or metric to be named in a user interface of the user.

A second region 806 shows entity-based information cards (e.g., “entity-based cards”). The entity-based cards shown represent templates or card types that can be populated to provide information about different types of entities. For example, there can be different entity-based card types for employees, customers, vendors, products, locations, and so on. The server system 110 can send an instance of an entity-based card when an entity is referenced. For example, if a company name is detected in a user interface for a user, the server system 110 can generate an entity-based card instance for the customer company that is named. The server system 110 can detect that the text of the user interface includes a name that matches a customer company name keyword. The server system 110 then selects the customer entity-based card template and populates it with the information for the named customer.

The user interface 800 also includes a dataset management region 808 that lists datasets linked to the current channel being created or edited. In this case, four data sets are shown. The interface 800 can enable the administrator 103 to add or remove datasets from being used in the channel. In addition, the interface 800 can provide controls to fine-tune how each dataset is used, for example, to specifically include or exclude subsets of data (e.g., so that some attributes or metrics are available in the channel while others are not). In addition, many data sources 140 or third-party services or system 142 may provide multiple different datasets. For example, connecting to one cloud-computing account or database may result in multiple different tables, data cubes, data repositories, or other datasets. The dataset management region 808 can provide controls for the administrator 103 to selectively add specific datasets or data collections from data sources, and to customize how each dataset is used.

FIG. 8B is an example user interface 810 that shows information for a particular channel, labeled “HQ Employee Channel” 812. The user interface includes a toolbar 814 where the administrator 103 can select to view and edit various different aspects of the channel, including the overall configuration, the audience (e.g., users and user groups), content (e.g., information cards), datasets, and domains (e.g., network addresses or Internet domains in which different features or content are active). The administrator 103 has selected the “content” group to view and edit which types of information cards will be generated and presented.

The user interface 810 includes a region 816 that shows a list of information card types or templates, along with a control in the upper right corner to set each information card type as included (e.g., with a check mark) or omitted (e.g., open circle). The information card types here represent insight cards, which respectively provide information such as most returned items, quarterly revenue, item sales this month, progress against weekly goals, customer complaints, low customer rating items, and so on. These information card types can be based on data from any of the various datasets or data sources 140 or third-party services or systems 142 connected for the channel.

In some implementations, the server system 110 has a set of pre-determined information card types or templates available in a library. The administrator 103 can then use the interface 810 to select some or all of the system-provided, predesigned information card types in the channel. In some implementations, the server system 110 stores different sets of information card types or templates for each of multiple different data sources 140 or third-party services or systems 142. For example, the server system 110 can store a first set of information card types or templates that are designed to notify users about data from a first source (e.g., Salesforce), based on the types of data typically available from the first source and the APIs for communicating with the first source. The server system 110 can store a second set of information card types or templates that are designed to notify users about data from a second source (e.g., ServiceNow), based on the types of data typically available from the second source and the APIs for communicating with the second source. As a result, the server system 110 can provide administrators with predesigned information card templates that are compatible with and ready to connect to the various data sources that the users connect.

The information card types and templates in the region 816 can include information card types that the administrator 103 creates. For example, the server system 110 can provide an interface that includes an information card designer interface so the administrator 103 can provide his own text, visualization types, formatting, data fields (e.g., to pull data from a data source), and so on.

FIG. 8C shows another example user interface 820 for the administrator 103 to manage the types of information card that are presented in channels. The user interface 820 shows information card templates generally, across the administrator's account as a whole, and so it shows information card templates from different channels. In other words, the user interface 820 is intended to provide an overall view of the combined set of information card types across multiple channels managed by the administrator 103, where the different channels may have different audiences, datasets, and other properties. The user interface 820 shows two different categories of cards, stream cards or insight cards 822, as well as entity-based information cards 824.

The user interface 820 shows a region 826 that lists stream cards or insight cards (e.g., the types or templates, not specific instances of those card types). The region 826 shows various columns of information that describe the information cards, including a name 828a, a data source 828b from which the card's information is derived, an owner 828c of the card, an indication of the channels assigned 828d, a time or date of the last update for the card 828e, a creation date 828f or creation time for the card, a description 828g.

As the data source 828b column indicates, different card types can be based on data from different data sources, e.g., Salesforce, uploaded files, ServiceNow, etc. This allows the information cards generated for a single channel to provide information from multiple different sources and systems. In addition, individual user streams can provide a combination of multiple channels, which further allows content of different types to be combined.

The column indicating channels assigned 828d shows that some of the created card types or templates are assigned to provide content for a first channel (e.g., “1”), while other card types or templates are assigned to provide content for a second channel (e.g., “2”). One of the card types, “Progress Against Weekly Goals,” is not assigned to any channel, but a button or other control is provided for the administrator 103 to interact and assign the card type to one or more of the existing channels. Card types can be assigned to multiple channels if desired.

FIG. 8D shows another user interface 830 that shows information for an administrator 103 to view and edit information about users and user groups. The user interface 830 and similar user interfaces can be used to create or edit user groups, to assign users to channels to receive information, to adjust access privileges, and otherwise update the sets of users that receive information cards. The user interface 830 shows a list of individual users 832 as well as a list of user groups 834. For each list, the user interface 830 can show information about the members, such as a name, role, status, channel (or channels) assigned, time of last activity, and time or date that the user was created or added in the system. The server 110 can enable administrators to adjust the user and user group settings generally, e.g., for a company's account as a whole, or separately for individual channels.

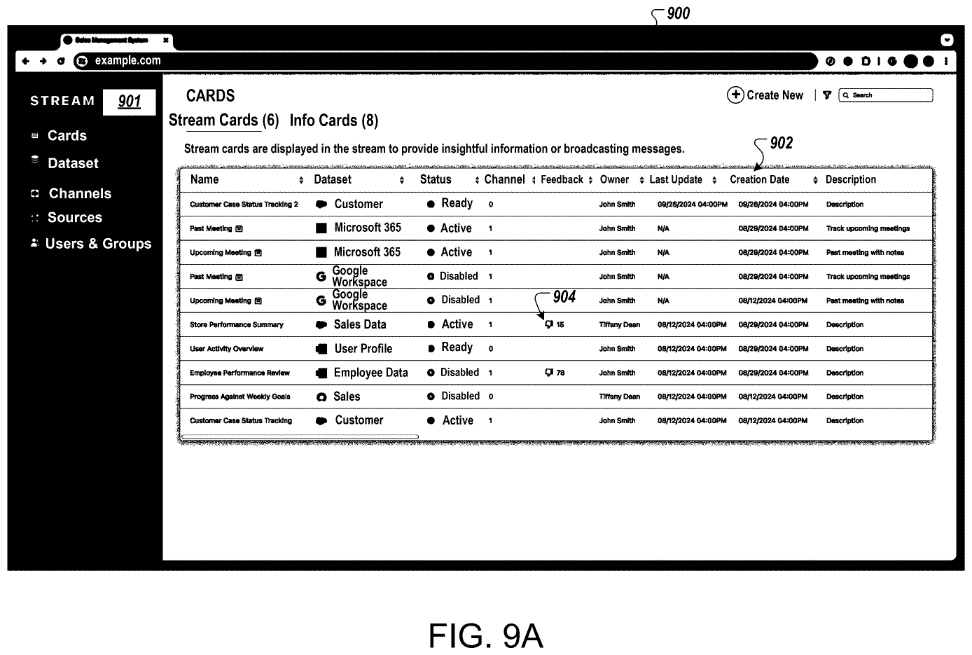

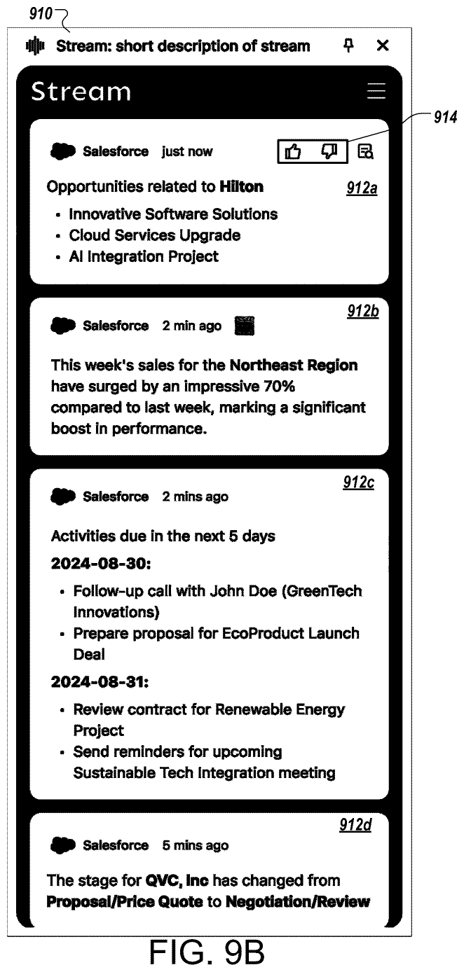

FIG. 9A is a diagram showing an example user interface 900 that shows information about information cards and feedback from users. These are interface shows one of various views that can be presented to the administrator 103 to assist in managing the channels of information that are provided to users. The system includes a navigation pane 901 that enables access to views for setting many different properties and settings for the account managed by the administrator 103.

In the navigation pane 901, the view or tabs for cards and datasets can be general settings across multiple channels. For example, the administrator 103 can import or connect to various different data sources 140 and third-party services or systems 142, and then define datasets from those sources. Then, each channel can be defined to use specific datasets from the overall set that the administrator 103 prepared. As another example, the administrator 103 can create or select different information card types or templates, and then assign each information card type or template to one or more channels. Some information card types may be shared by different channels (e.g., multiple channels may each include the same type of information card). Other information card types may be assigned to a single channel.

The navigation pane 901 can provide access to view to set other properties also. For example, a channel view can show information about channels that have been created for a particular company, as well as provide access to create new channels or to edit existing channels. Similarly, a sources view can show the data sources 140 and third-party services or systems 142 that have been connected, as well as provide controls to add additional sources or edit sources. The view for users and groups can show the users and groups of users that are invited to or authorized to receive stream content. The interface can enable the administrator to adjust which users or user groups can receive information from each channel.

The example of FIG. 9A shows the card view, with a region 902 showing a list of stream information cards or insight information cards that have been defined. The region 902 shows a list where the rows provide information about different information card types or templates. These include information card types of “Customer Case Status Tracking 2,” “Past Meeting,” “Upcoming meeting,” “Store Performance Summary,” “User Activity Overview,” “Employee Performance Review,” “Progress Against Weekly Goals,” and “Customer Case Status Tracking.” Each of these information card types defines a set of content to provide as well as a corresponding condition to trigger presentation.

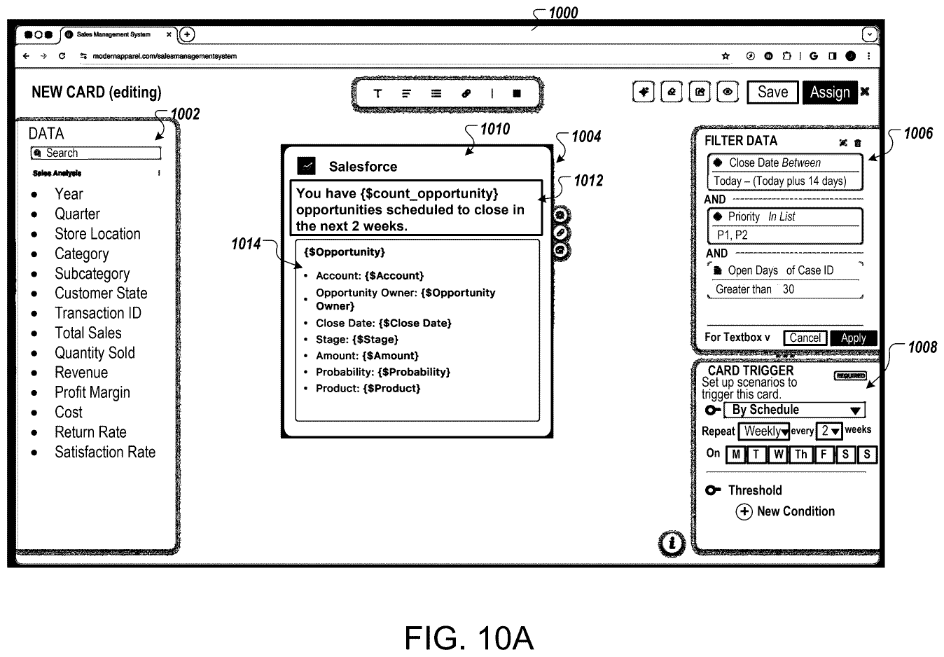

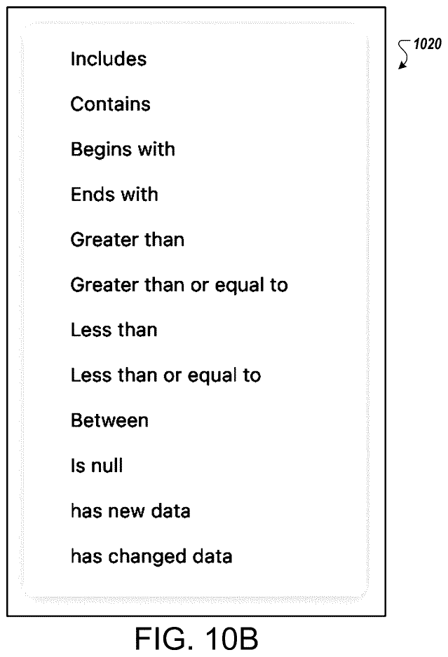

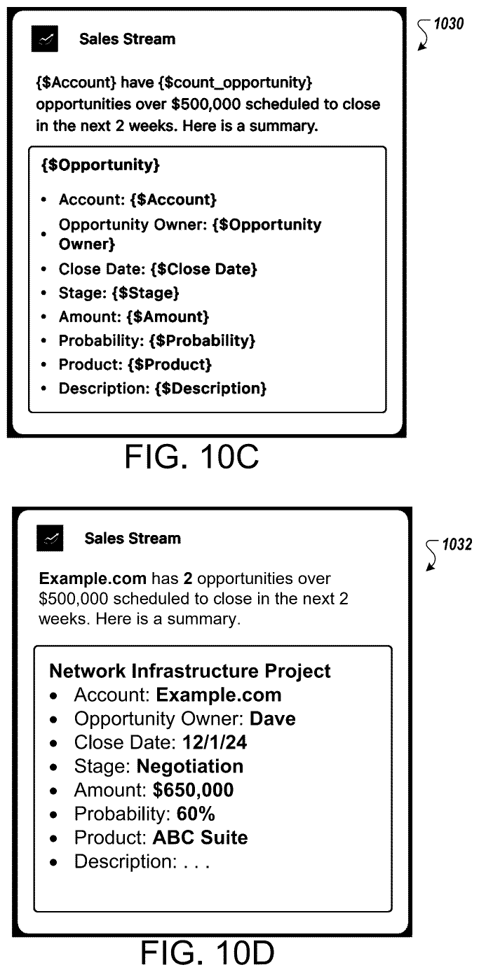

The user interface 900 can be configured to make the rows representing the different card types interactive, so that by interacting with (e.g., clicking, tapping, etc.) a row, the administrator 103 initiates display of a configuration interface to view and edit corresponding information card template, so the administrator 103 can change, for example, card content (e.g., text, visualizations, formatting, layout, etc.), the types of values or fields that are populated to make information card instances, the dataset from which information is taken to populate information card instances, the status of the card type, the assigned channel(s), the description, the conditions for triggering generation and/or presentation of an information card from the card type, and so on. For example, in some implementations, clicking on a row for a card type opens a card editor interface such as shown in FIG. 10A.

The information card types, as discussed further below, do not represent a single instance but rather a template in which relevant information of a particular type can be populated. For example, an upcoming meeting information card type defines when the upcoming meeting card should be presented and what type of information should be included, but the actual instance of that information card will be populated based on the particular meeting that is upcoming for a specific user. Different users will receive different content populated into their information card instances due to the differences in their calendar event content.

The region 902 includes a variety of types of information for each of these information card types, including a name, a data set or data source from which the information card derives its data, a status of the information card type, a channel identifier specifying which channel the information card type is assigned to, an indication of user feedback for the information card type, an owner of the information card type, a time and date of last update to the information card type, a creation date and time for the information card type, and a text description for the information card type.

In the example, the various information card types are based on information from various different data sources 140 or third-party services or platforms 142, such as Salesforce data, and Microsoft 365 data, Google workspace data, excel spreadsheet data, ServiceNow data, and so on. Each data source can also provide multiple different data sets. For example, the salesforce platform can provide a customer dataset as well as a sales data dataset. The information card types or templates can each be linked to specific data sets within a data source, including by referencing specific data objects (e.g., columns, attributes, metrics, field types, etc.).

In the region 902, the status column for the information card types indicates a variety of different statuses, such as ready, active, or disabled. An information card type that is active indicates that the server system 110 is monitoring for the triggering condition to occur and will provide information card instances of that type when triggered. The status of disabled indicates that the information card type is set to not be used until manually reenabled. The status of ready indicates that the information card type has been linked to a data source and may be validated for use, but has not yet been activated (e.g., may not be assigned to a channel, or users may not be granted appropriate permissions, and so on).

Also in the region 902, the channel column indicates which channel(s) the card type or template is assigned to. In this example, there are two channels, a first channel (e.g., “0”) and a second channel (e.g., “1”). Creating different channels enables the administrator 103 to more easily provide information card feeds with different topics or from different data sources to targeted to different sets of users.

The region 902 also shows feedback provided by users in response to display of information cards of the various types. For example, the score 904 indicates that instances of the “Store Performance Summary” card type (presented at different times to different users, with different values or stores represented in the various instances) were disapproved by users 15 times. This indicates that information cards presented based on the “Store Performance Summary” card type have not been useful for at least some of the users. The server system 110 can perform various operations to learn from this feedback and to improve the relevance of the presented information cards over time.

For example, the server system 110 can have a learning engine feature that is designed to enhance the relevance and context-appropriateness of stream cards by leveraging AI/ML models 132 to analyze user interactions with the cards. Based on the users' behavior, such as dismissing, redirecting, or indicating relevance, or based on the viewing context for a card, the server system 110 will continually refine the insights it delivers to ensure they become more personalized and relevant over time. As a result, users will receive cards tailored to the content they interact with and the topics or other elements (e.g., accounts, projects, documents, etc.) that they view.

To facilitate learning, the server system 110 performs data collection and analysis, such as by capturing information about user interactions with each card, including the time spent on a card, clicks (e.g., on links or other controls) and explicit relevance feedback (e.g., user-supplied ratings). The server system 110 will analyze interaction patterns to identify trends and preferences unique to each user (e.g., a particular user has viewed cards for company MassMutual more times than usual over the past week). The server system 110 will also analyze email and calendar content to build a user interest profile for each user. The server system 110 also tracks keywords that a user commonly views to build the user's user interest profile.

To create and update the user profiles, the server system 110 can develop dynamic user profiles that evolve based on ongoing interactions, to capture the user's changing interests and priorities. The server system 110 allows for the aggregation of interaction data to refine the user profile without compromising individual privacy.

The server system 110 can train an AI/ML model to process interaction data and predict the types of insights likely to be of interest to each user. In some implementations, the AI/ML model can be a classifier trained based on the interaction patterns and feedback of many different users. The classifier can be configured to receive input that describes a user's interaction patterns and user context, as well as data describing an information card or topic. The classifier can then output a classification or score indicating a level of relevance of the information card or topic for the user, given the user's interaction patterns and current context. For example, the output of the classifier can be a score (e.g., from 0 to 1 indicating a likelihood that the content is currently relevant), a classification and confidence score for the classification, or another type of output.

In some implementations, the AI/ML model can be a large language model (LLM) that has been further trained with additional user profiles, user feedback, and user interaction data. The LLM model has information about the semantic meaning and relationships among text data from its base training, and further training can help tailor the processing to understand and recognize trends and relationships that occur in the information card delivery system.

As another example, the AI/ML model can be a LLM that is not specifically trained or updated based on card feedback data. For example, a general LLM can still be used to assess relevance, especially when the instruction prompt to the LLM includes or refers to examples or criteria for judging relevance. A session of communication with the LLM can be initialized with feedback data for many users, and/or for the profile data for a specific user, showing examples of pairings of user contexts and information cards designated as being useful, or with the feedback data indicating that they were useful (e.g., positive user ratings). Similarly, the LLM can be provided examples of pairings of user contexts and information cards designated as not useful, or with the feedback data indicating that they were not useful (e.g., negative user ratings). The LLM can then use the examples and profile data for a user to assess, for new information cards that are triggered for channels a user is subscribed to, the relative importance or relevance of the cards. The LLM can then provide classifications, rankings, or scores for information cards which the server system 110 can use to adjust which information cards are actually presented to each user.

In some implementations, the server system 110 includes features to ensure that the AI/ML model can discern between short-term interests and long-term preferences. This can be done in various ways, including based on including different sections in a user profile, one showing short-term interests (e.g., in the last hour, last day, etc.) and longer-term interests (e.g., in the last week, month, year, etc.). Labeling the interaction and profile data for the corresponding time ranges can help the AI/ML model distinguish between them. Similarly, a custom-designed model can use one set of input features to specify short-term interests, and a second set of input features to specify long-term interests. If an LLM is used, the server system 110 can include an instruction to the LLM to apply different criteria when matching to the different categories of interests. As another example, measures of interests that remain consistent over time can be given a special designation or higher weighting. In some cases, the user profile can be repeatedly updated to indicate the scores or rankings of the topics, keywords, and other items that are most common or that have the highest favorability across different time ranges, e.g., day, week, month, year, etc. The information about the frequency or favorability across these different time ranges can show the AI/ML model which topics are short-term and which persist across large durations of time.

The server system 110 is configured to provide adaptive content delivery, by using algorithms that dynamically adjust the content of stream cards presented to the user, based on the evolving user profile. The computer system 110 can test and validate the relevance of the cards delivered as a result of the AI/ML model's predictions. For example, cards predicted to be relevant can be presented, and user feedback and interaction measures can be used to confirm or disprove the expected relevance, leading to further updates to the user's profile.

The interface for showing information cards to users can include a simple and intuitive feedback mechanism for users to rate the relevance of cards, such as thumbs up or thumbs down buttons, star icons to select a rating (e.g., 3 out of 5 stars), etc. The server system 110 can use the feedback to provide immediate adjustments to the AI/ML model's output indicating classifications and relevance scores.

The system can also provide users a settings panel where users can adjust their preferences for insight categories, frequency, and other parameters that influence the cards provided by the system, and in some cases, influence the AI/ML model's output indicating relevance of information cards to the user.

In some implementations, the server system 110 is configured to provide transparency to users, such as by offering users insights into how their data is being used to personalize their experience. One example is a icon or other control, or a hyperlink “Why am I seeing this?,” that the user can click to receive an explanation of the factors in a data set or the user's context that led to (1) the card being triggered for presentation, and (2) the relevance of the card being sufficiently high to be presented to the user at the current time. More generally, the interface for users can have a section where users can see how their interactions are shaping the set of cards they receive.

In some implementations, the interface for presenting information cards to user can include controls that provide options for users to easily snooze (e.g., hide and/or prevent from repeating) types of insight cards as part of the learning process. In addition, the system can provide an interface that allows users to set and adjust preferences for the types of cards they wish to see.

The learning in the system can be measured and tracked through various measures. For example, the system is designed to provide relevance score improvement, e.g., to increase in the average relevance score of cards as rated by users over time. In addition, the system is designed to reduce the card dismissal rate, e.g., to decrease in the rate at which users dismiss cards, indicating improved content relevance. In addition, the system can identify improvement through an increased adoption rate for the stream viewer, e.g., based on an increase in the number of users who start using the feature and continue over a defined period. Similarly, effectiveness can be measured through the retention rate, e.g., an increasing percentage of users who continue to use the feature, indicating sustained value and satisfaction. Over time, model accuracy should improve, as the AI/ML model's accuracy in predicting user preferences based on interaction data increases. Changes to the user profiles, AI/ML models (and the inputs to the model), and the card presentation settings that improve these measures can be reinforced or continued to improve the overall performance of the system.

FIG. 9B is a diagram showing a stream viewing pane 910 that shows a stream view for a user. The viewing pane 910 can be presented as a sidebar next to a web page or application window, as a overlay over a web page or application window, or in another form. The viewing pane 910 shows information cards 912a, 912b, 912c, and 912d.

In the example, the information card 912a shows sales opportunities for an entity, e.g., Hilton. The information card 912a lists three opportunities related to this company, each of which can be made interactive to open the corresponding item in the application or platform from which the information was taken (e.g., Salesforce in this example).

The information card 912a includes feedback controls 914 that a user can interact with (e.g., tap, click, etc.) to indicate if the information card 912a was useful (e.g., thumbs up) or not (e.g., thumbs down). The server system 110 receives and collects the feedback from users, which allows the server system 110 to learn improved relevance measures and priority scores to select better information cards for user. In some implementations, the server system 110 use the feedback from users to automatically adjust the presentation of information cards, such as to promote or increase priority scores for card types that receive positive feedback and to demote or decrease priority scores for card types that receive negative feedback. In addition, the server system 110 can store information indicating the presentation contexts associated with feedback (e.g., the network addresses or domains, user interface text, entities or topics, etc.) and use this information to more carefully adjust the presentation characteristics. For example, the server system 110 can use the feedback and context information to identify context characteristics that are associated with higher or lower feedback, and use this information to tailor the relevance or priority differently for those different contexts.

The server system 110 can also indicate the feedback to the administrator 103 in the user interface 900, which the administrator 103 can use to adjust the content of channels, such as by disabling information cards or editing information cards (e.g., adjusting the content or triggering conditions for the information cards).

Although feedback controls 914 are shown on only the information card 912a, similar feedback controls can be provided on each of the various information cards presented to a user. In addition, other types of direct and indirect feedback can be collected. For example, the information cards can be presented with interactive controls to receive star ratings (e.g., 1-5 stars), numerical ratings, and other types of feedback. As another example, information cards can be provided with a control to dismiss an information card, or save an information card. Information cards that are frequently quickly dismissed can be inferred to be less important in some cases, while information cards that are saved, are interacted with, or are hovered over or remain in focus on a user interface for a significant time can be inferred to have positive feedback.

The information card 912b shows that sales in the Northeast Region have increased by 70% compared to the last week. The corresponding card definition 151 can be defined to indicate changes in sales by region, and the corresponding trigger or condition can be that the card is generated when the sales amount meets or exceeds a threshold, such as 50%. The sales increase of 70% satisfied the trigger and so the server system 110 generated the information card 912b for a particular channel that is part of the stream for the user of FIG. 9B. Then, the server system 110 calculated that the relevance of the information card 912b is sufficiently high (e.g., relative to other cards or to a minimum threshold) to cause the information card 912b to be presented to the user.

Another example information card 912c shows activities that are due for the user in the next five days. This information card 912c shows an example of a card that is triggered and generated based on the current time, and the fact that there are items do within the window of the upcoming five days, instead of based on identifying keywords or entity names that occur in a web page or user interface. In general, administrators can define the triggers and conditions 152 for generating information cards based on many different factors, including those that are not based on content of a user interface.

As another example, the information card 912d indicates that the stage of a process for the entity QVC Inc. has changed from a “Proposal/Price Quote” status to a “Negotiation/Review” status. This information card 912d was generated based on a status change or event specified by a third party system or service 142 (e.g., Salesforce), and other information cards indicating similar types of change in status can be generated for other entities and other processes. In this case, the server system 110 determined that the status change indicated in the information card 912d is relevant to the user based on the content in the user interface. In particular, a web page shown on the user's device includes a discussion about the particular sales process that is ongoing with QVC Inc., and so the change in the status or stage of that process is particularly relevant.

In some implementations the information cards in a user's information stream are provided as a feed in which new items are populated sequentially. For example, a new information card can be inserted at the top of the viewing pane 910 and other existing information cards can be pushed down as a result. For example, the information card 912a may be most recently presented, the information cards 912b and 912c were presented 2 minutes ago, the information card 912b was introduced 5 minutes ago, and so on. Information cards may be removed or reinserted into the stream in some cases as the context of the user changes and thus the relevance of those cards to the user changes.

FIG. 10A is a diagram showing an example of a user interface 1000 for designing information cards. The user interface 1000 allows the administrator 103 to create new information card types or templates or to edit existing information card types or templates. The administrator 103 can use the user interface 1000 to set a variety of card characteristics, such as the text, layout, formatting, interactive controls presented, data fields to be populated, data sources to draw from in creating a card, data filters to apply, and conditions for triggering card presentation.

The user interface 1000 shows an example of creating a new card. A data toolbar 1002 on the left shows the available data objects that have been imported or connected for the company or organization that the administrator 103 is associated with. After data sources 140 and third-party services or systems 142 are connected, and datasets from those sources are imported, the service system 110 extracts the logical objects available. For example, the server system 110 can create a data model or schema that specifies the types of data represented by different columns, aggregations of data, and other values obtained from the imported data sets. In the example, a single “Sales Analysis” dataset is shown, and there are a variety of attributes (e.g., year, quarter, store location, category, sub category, customer state, and transaction ID) and metrics (e.g., total sales, quantity sold, revenue, profit margin, cost, return rate, and satisfaction rate). Each of these data objects is defined so that values for the object are derived from a corresponding portion of the dataset (e.g., a value from a particular column of a table, a particular type of aggregation or calculation result, etc.). Each of the data objects is available to the administrator 103 to display in an information card or use in criteria for triggering the information card.

The user interface 1000 shows an information card template 1004 that is being edited. It shows an icon 1010 and name of the data source that the information card is based on, e.g., the Salesforce application. The card template 1004 also includes a text region 1012 that provides a message to be presented, including a field label in brackets (e.g., “{$count_opportunity}”) that specifies a data object to populate the field. In particular, the “{$count_opportunity}” field label refers to a particular data object, which is a metric indicating the number of opportunities associated with a user or account. In the future, when the template 1004 is used to generate a information card instance, the server system 110 will determine the current number for the user based on the current status and set of data at that time.

The card template 1004 also includes additional information about opportunities from the dataset, such as a data region 1014 with values taken from other data objects as shown by the corresponding data object labels or fields. These include an opportunity name (e.g., {$Opportunity}), an account name (e.g., {$Account}), an opportunity owner (e.g., {$Opportunity_Owner}, a close date (e.g., {$Close_Date}), a stage (e.g., {$Stage}), an amount (e.g., {$Amount}), a probability of success (e.g., {$Probability}), and a product name (e.g., {$Product}). Each of these types of information takes information from a corresponding data object defined for a dataset that the administrator 103 has imported or linked for use in generating information cards.

The user interface 1000 also includes a filter panel 1006 that the administrator 103 can use to filter the dataset when populating the information cards based on the information card template 1004. For example, the card template 1004 is intended to describe opportunities for the next 2 weeks, so the data range considered is filtered to items having a close date in a range from today to today plus 14 days. In addition, the data set is further filtered to items that have priority of level P1 or P2 and which have a case identifier open for at least 30 days (e.g., value of Open Days is greater than 30). These filters provide narrow the window of data from the dataset that is used to calculate or retrieve values to populate the card template 1004 when creating an information card instance. For example, only opportunities that meet all of the criteria set in the filter panel will be counted for the opportunity count and will be listed and described in the data region 1014.

The user interface 1000 also includes a trigger panel 1008 that includes controls to set the conditions or criteria for the server system 110 to use in determining when to present information cards based on the card template 1004. In the example, no card trigger criteria have been set yet, but the controls enable the administrator 103 to select to trigger generation of an information card from the card template 1004 based on a schedule or based on a threshold or other condition. The schedule settings allow the information card to be provided at an interval, such as daily, weekly, monthly, quarterly, etc., including at specific days and/or times. The controls to set a threshold or other condition enables the administrator 103 to set any of various types of events or conditions to cause the information card to be presented.

When the administrator 103 selects to add a threshold or add a new condition, the trigger panel 1008 can present a text field to receive an expression that specifies when to show the information card. The administrator 103 can reference the data objects for one or more of the dataset that have been imported or connected. The filter panel 1008 can be configured to receive and process an expression in any of various forms, such as a mathematical expression or relationship (e.g., $count_opportunity>0), a Boolean expression, a natural language statement, a SQL statement, Python code, or in another form. The administrator 103 can reference data objects to be referenced against a threshold using labels, names, or identifiers for the data objects shown in the data toolbar 1002, e.g., “Total Sales>$100,000,” “show when Return Rate exceeds 3%,” “$satisfaction_rate<90% AND $quantity_sold>100.”

For example, the filter panel 1008 can allow administrators to specify a condition in natural language, and the server system 110 can use the AI/ML models 132 to generate an expression that the server system 110 can use to efficiently and accurately detect the presence of the condition (e.g., an expression referencing database field values, a structured query language statement, computer code, etc.). The user can specify in natural language the condition that should apply, such as a description of the threshold that should apply, such as “show when sales exceed 2000 units,” or “monthly sales differ from previous month by at least 20%,” or “when the status of employee John Doe changes.” The server system 110 receives the natural language statement and can processes it with the AI/ML models 132 to convert or translate the statement to a format that the server system 110, or an associated database processing system or other data processing system, can apply.

The processing of user-entered threshold statements can include mapping terms in the user-entered natural language text to data types available from the connected datasets and data sources, such as the data objects listed in the data toolbar 1002. The processing of natural language statements can include identifying operators and expressions (e.g., equals, less than, greater than, etc.) that operate on the values of data objects to apply the threshold. In some cases, the AI/ML models 132 are provided a data model that lists the data objects (e.g., metrics, attributes, etc.) that are available in the connected datasets, as well as descriptive data (e.g., names, descriptions, metadata, sample values, and so on) for each data object. The AI/ML models 132 can use the semantic meanings of the user-entered terms to select the best-matching data objects from the data model, which may represent database columns, aggregation results, or other data objects, including potentially values obtained from third-party services or systems through an API. The AI/ML models 132 can be asked to provide an output in a form that the server system 110 can apply efficiently, such as an SQL statement, Python code, a mathematical expression, a Boolean expression, etc.

In some implementations, the card trigger panel 1008 guides the administrator 103 in creating a trigger condition statement. For example, as the administrator 103 types, the system can use the names or other identifiers for the data objects that are available to dynamically provide drop-down list options or autocomplete suggestions for data objects. This can enable administrators to quickly select from among the set of known data objects defined in the data models for the imported datasets, without having to type the names. Similarly, the trigger panel 1008 can provide a drop-down list or other control that lists various operators or relationship types (e.g., equals, less than, greater than, etc.) that can specify a relationship for the condition. By guiding the administrator to select from the sets of known items (e.g., data objects, operators, etc.) recognized by the server system 110, the controls in the trigger panel 1008 can increase the speed of creating trigger conditions, while ensuring that the trigger condition will be able to be evaluated by the server system 110.

FIG. 10B is a diagram 1020 showing an example list of operators for defining conditions to trigger presentation of information cards. The list shows an example of types of operators or relationships that the filter panel 1008 can present or suggest to an administrator 103 for defining a trigger condition. Various operators can be configured to specify an operation or relationship between a variable or data type, X, that precedes the operator, and a value, Y, that follows the operator. For example, for the operator “includes,” it would be to create the condition “X includes Y,” where the administrator would specify a particular data object as the variable X and the administrator 103 would specify a value Y as the reference value to be used. The various operators may apply to different data types, with some operating on numerical data, others on text or string data, and so on.

The example shows operators of includes (e.g., a variable representing text or a set of values includes a particular value), contains (e.g., a variable representing text or a set of values contains a particular value), begins with (e.g., a text string begins with certain text characters), ends with (e.g., a text string ends with certain text characters), greater than (e.g., a variable is greater than a threshold number), greater than or equal to (e.g., a variable is greater than or equal to a threshold number), less than (e.g., a variable is less than a threshold number), less than or equal to (e.g., a variable is less or equal to a threshold number), between (e.g., a variable is between two values and so is in a particular range), is null (e.g., a variable has a null or unassigned value), has new data (e.g., a variable or field had data added), and has changed data (e.g., a value of variable or field has changed). When an administrator 103 provides a statement in natural language, and the AI/ML models 132 are used to interpret and convert to an expression for the server system 110 to apply, a list of supported operators can be provided as input to the AI/ML models 132. The AI/ML models 132 can be instructed to select the operator(s) that best describe the relationships specified in the natural language statement, so that the resulting output uses the operators that the server system 110 can apply.

Once the trigger condition has been set and a card template 1004 is made active, the server system 110 can monitor for the occurrence of the trigger condition being satisfied and generate an information card in response. For example, if the trigger condition is that a customer's sales reach 100 units, the server system 110 can monitor the data from the dataset that describes amounts of units sold, and detects when any of various customers reaches the threshold of 100 units. In other words, for a single variable of units sold (by customer), the server system 110 can monitor the data across all of the customers to detect each instance where a customer meets the threshold, and then provide an information card for each customer whose sales meet the threshold. In this manner, a single card template 1004 and corresponding trigger condition can result in many different information card instances based on different records, entities, or topics over time.

After many card templates have been created and made active, the server system 110 will have many different conditions to check for. The server system 110 can repeatedly check the conditions for the various card templates across the many records in the datasets that are connected, in order to trigger generation of cards of any type as the are triggered. In some implementations, the server system 110 refreshes or updates the datasets periodically (e.g., every 10 minutes, each hour, each day, etc.) and updates the trigger condition evaluation each time. In other cases, the server system 110 is configured to receive notifications of events, data changes, status changes, or other information from data sources, and the server system 110 re-evaluates conditions as new or changed data is identified.

FIG. 10C shows an example of an information card template 1030, and FIG. 10D shows an example of an information card instance 1032. The information card instance 1032 shows how the fields in the information card template 1030 would be populated with data from a dataset to create the card that is presented to a user when the corresponding trigger condition is detected to be satisfied.

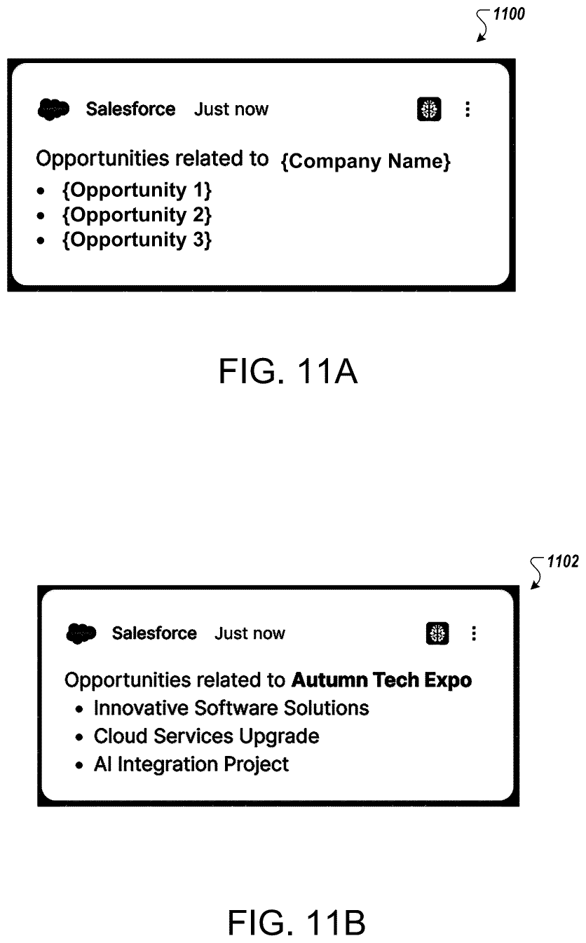

FIG. 11A shows another example of an information card template 1100, and FIG. 11B shows an example of an information card instance 1102. The information card instance 1102 shows how the fields in the information card template 1100 would be populated with data from a dataset to create the card that is presented to a user when the corresponding trigger condition is detected to be satisfied.

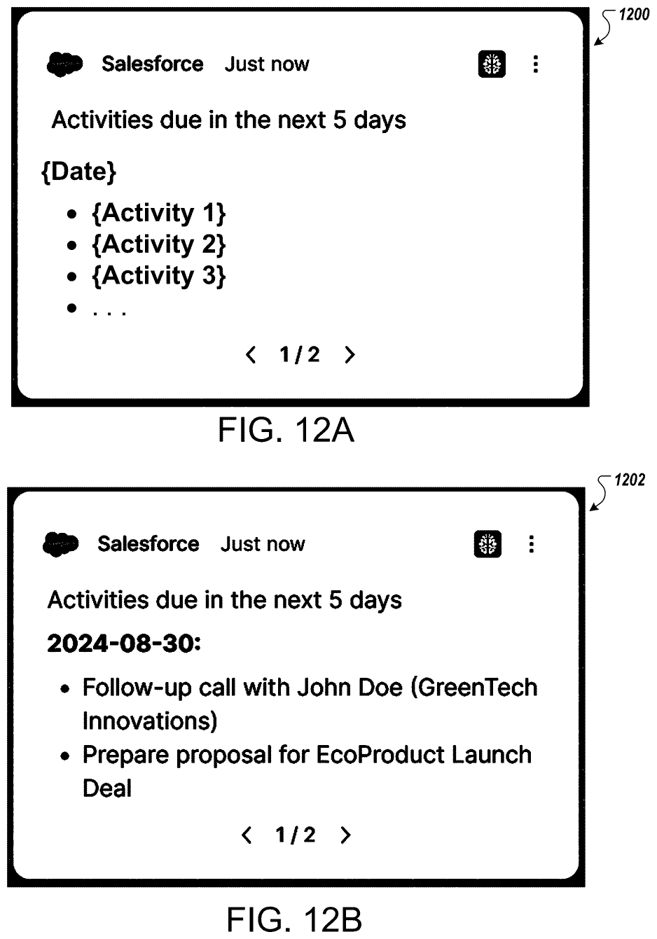

FIG. 12A shows another example of an information card template 1200, and FIG. 12B shows an example of an information card instance 1202. The information card instance 1202 shows how the fields in the information card template 1200 would be populated with data from a dataset to create the card that is presented to a user when the corresponding trigger condition is detected to be satisfied.

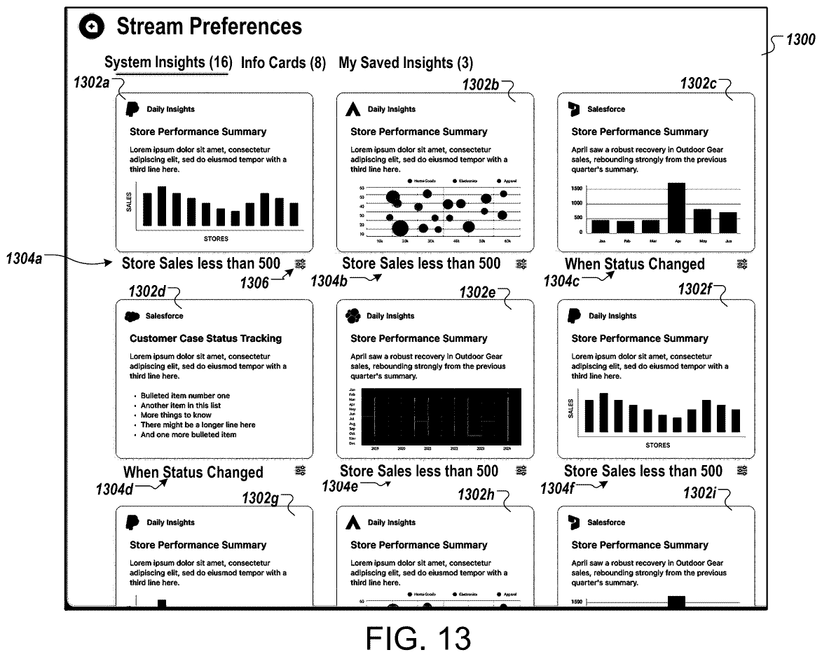

FIG. 13 is a diagram showing an example user interface 1300 showing information card templates 1302a-1302i and corresponding trigger conditions 1304a-1304i. After card templates are created, the collection of card templates can be presented for the administrator 103 to view and edit. Different card templates show different text, layout, formatting, and so on, and are configured to include different types of values from the dataset(s) that have been connected to or imported for the account. In addition, different card templates can have trigger conditions based on different data objects, different threshold values, and so on.

As an example, the card template 1302a is configured to provide a store performance summary, and the corresponding trigger condition 1304a specifies to create and present the card for a store when the store's sales are less than 500 units. As another example, the card template 1302d is configured to provide information about customer case status tracking, and the corresponding trigger condition 1304d specifies to create and present the card for a user when the status of the user's customer cases has changed.

For each information card template 1302a-1302i, an interactive control can be provided that, when interacted with by the administrator 103, causes presentation of an interface for adjusting card template properties, e.g., content of the card, relationships or links to data sets, trigger conditions, etc. For example, interacting with the control 1306 can cause the corresponding information card template 1302a to be opened in the editor view of FIG. 10A.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the claims. For example, the steps recited in the claims can be performed in a different order and still achieve desirable results.

1. A method performed by one or more computers, the method comprising:
providing, by the one or more computers, an interface configured to create or edit information card templates for a channel configured to provide information cards based on the templates to user devices, wherein the information cards are provided selectively to user devices of users associated with the channel based on respective contexts of the user devices;
receiving, by the one or more computers, first input through the interface, wherein the first input indicates content of a first information card template, including one or more data objects or data fields to be used in populating the first information card template;
receiving, by the one or more computers, second input through the interface, wherein the second input specifies one or more criteria for presenting an information card based on the first information card template;
storing, by the one or more computers, a record for the first information card template that indicates (i) the content indicated by the first input and (ii) one or more criteria specified by the second input; and
configuring, by the one or more computers, the channel to provide information cards based on the first information card template, wherein information cards are populated with keywords or topics from the respective contexts of the user devices and are presented in response to determining that the one or more criteria are satisfied.

2. The method of claim 1, wherein the one or more data objects or data fields designated for the content of the first information card template comprise a first data object from a particular data source or data set, selected from among a data model or list of data objects available to a user of the interface; and
wherein the record for the first information card template designates the particular data source or data set as a source of values for the first data object.

3. The method of claim 1, wherein the one or more criteria comprises one or more conditions that trigger generation of or presentation of an information card based on the information template.

4. The method of claim 3, wherein the one or more conditions include at least one of:
a condition of a timing condition;
a condition of a context of a client device; or
a condition that specifies a status of a value for a data object in a data source or data set.

5. The method of claim 1, wherein configuring the channel comprises assigning the first information card template to the channel, such that the information card template is used to selectively provide information cards to users that are associated with the channel.

6. The method of claim 1, wherein configuring the channel comprises configuring the channel by establishing repeated monitoring whether the one or more criteria are satisfied.

7. The method of claim 6, wherein the repeated monitoring comprises monitoring changes in the contexts of the client devices to detect when the respective contexts of the client devices cause the one or more criteria to be satisfied for one or more users.

8. The method of claim 1, wherein the interface is a user interface that includes first interactive controls configured to receive user input to (i) select or specify fields that represent data objects from one or more data sources or data models, and (ii) insert the fields for the data objects into the first information card template.

9. The method of claim 8, wherein the information card templates are each configured to generate information cards for each of multiple different values of the data object field, such that a single information card template can be used to generate multiple different information cards based on (i) different values of the data object for different topics or records or (ii) different values of the data object over time for a single topic or record.

10. The method of claim 9, comprising providing, in the user interface, an interactive list of data objects from one or more data sources or data models, wherein the interactive list comprises items corresponding to the data objects that are selectable to add or insert fields corresponding to the data objects into an editable text field that specifies content for an information card template.

11. The method of claim 1, wherein the interface is a user interface that includes second interactive controls configured to receive user input to specify criteria to trigger presentation of an information card based on the first information card template.

12. The method of claim 11, wherein the second interactive controls are configured to define characteristics of an event, such that occurrence of an event with the specified characteristics triggers presentation of an information card based on the first information card template.

13. The method of claim 1, wherein the interface includes a user interface having third interactive controls configured to set user-specified filter conditions to apply for generating values from one or more data sets or data sources for (i) populating fields of the first information card template or (ii) determining whether the one or more criteria for presenting an information card based on the first information card template have been satisfied.

14. The method of claim 1, further comprising providing information describing content of the first information card template to one or more artificial intelligence or machine learning (AI/ML) models, the provided information comprising the first user input;
obtaining, from the one or more AI/ML models, output that indicates one or more candidate criteria for triggering display of information cards based on the first information card template; and
providing the one or more candidate criteria for display in the interface.

15. The method of claim 14, wherein the one or more AI/ML models comprise a large language model (LLM); and
wherein providing the one or more candidate criteria for display in the interface comprises at least one of providing the one or more candidate criteria in a chatbot interface, changing settings of one or more user interface controls of the interface to provide the one or more candidate criteria, or providing a selectable option that is selectable by the user to apply the one or more candidate criteria.

16. The method of claim 14, wherein the one or more AI/ML models are provided historical information indicating previous user interactions with previous information cards, and wherein the output that indicates the one or more candidate criteria is generated based at least in part on the previous user interactions.

17. The method of claim 14, wherein the one or more AI/ML models are provided historical information indicating previous user interactions with previous information cards, timing of the user interactions, and context data for client devices corresponding to the previous user interactions; and
wherein the output that indicates the one or more candidate criteria is generated based at least in part on the previous user interactions, the timing of the user interactions, and the context data corresponding to the previous user interactions.

18. The method of claim 1, comprising applying one or more artificial intelligence or machine learning (AI/ML) models to telemetry data or user interaction data, for an individual user or a group of users, to obtain from the one or more AI/ML models at least one of (i) customized criteria, determined based on the telemetry data or user interaction data, for triggering presentation of one or more information cards, or (ii) customized information card content determined based on the telemetry data or user interaction data.

19. A system comprising:
one or more computers; and
one or more computer-readable media storing instructions that are operable, when executed by the one or more computers, to cause the one or more computers to perform operations comprising:
providing, by the one or more computers, an interface configured to create or edit information card templates for a channel configured to provide information cards based on the templates to user devices, wherein the information cards are provided selectively to user devices of users associated with the channel based on respective contexts of the user devices;
receiving, by the one or more computers, first input through the interface, wherein the first input indicates content of a first information card template, including one or more data objects or data fields to be used in populating the first information card template;
receiving, by the one or more computers, second input through the interface, wherein the second input specifies one or more criteria for presenting an information card based on the first information card template;
storing, by the one or more computers, a record for the first information card template that indicates (i) the content indicated by the first input and (ii) one or more criteria specified by the second input; and
configuring, by the one or more computers, the channel to provide information cards based on the first information card template, wherein information cards are populated with keywords or topics from the respective contexts of the user devices and are presented in response to determining that the one or more criteria are satisfied.

20. One or more non-transitory computer-readable media storing instructions that are operable, when executed by one or more computers, to cause the one or more computers to perform operations comprising:
providing, by the one or more computers, an interface configured to create or edit information card templates for a channel configured to provide information cards based on the templates to user devices, wherein the information cards are provided selectively to user devices of users associated with the channel based on respective contexts of the user devices;
receiving, by the one or more computers, first input through the interface, wherein the first input indicates content of a first information card template, including one or more data objects or data fields to be used in populating the first information card template;
receiving, by the one or more computers, second input through the interface, wherein the second input specifies one or more criteria for presenting an information card based on the first information card template;
storing, by the one or more computers, a record for the first information card template that indicates (i) the content indicated by the first input and (ii) one or more criteria specified by the second input; and
configuring, by the one or more computers, the channel to provide information cards based on the first information card template, wherein information cards are populated with keywords or topics from the respective contexts of the user devices and are presented in response to determining that the one or more criteria are satisfied.
